(19) United States
(12) Patent Application Publication
(10) Pub. No.: US 2012/0230273 A1
(43) Pub. Date: Sep. 13, 2012

(54) METHOD FOR INDICATING HYBRID AUTOMATIC REPEAT REQUEST TIMING RELATION

(75) Inventors: Hong He, Beijing (CN); Yingyang Li, Beijing (CN); Chengjun Sun, Beijing (CN); Guanghui Zhang, Beijing (CN)

(73) Assignee: Samsung Electronics Co., Ltd., Suwon-si (KR)

(21) Appl. No.: 13/418,248

(22) Filed: Mar. 12, 2012

(30) Foreign Application Priority Data
Mar. 11, 2011 (CN) 201110062112.6

(51) Int. Cl. H04W 4/00; H04W 68/00; H04W 72/04

(52) U.S. Cl. 370/329; 370/328

(57) ABSTRACT

A method for indicating HARQ timing relation is provided by the present disclosure. First, an evolved NodeB (eNB) notifies a user equipment (UE) to enable an uplink/downlink subframe dynamic conversion function. Second, the eNB converts uplink and downlink subframes dynamically, and notifies the UE of the HARQ timing relation corresponding to the converted uplink/downlink subframe configuration. Finally, the eNB and UE communicate with each other according to the said HARQ timing relation. The dynamic flexible subframe is highly efficiently used in the present disclosure, and the object of changing the frame structure dynamically according to data service change more accurately and timely can be reached.

### CROSS-REFERENCE TO RELATED APPLICATION(S) AND CLAIM OF PRIORITY

This application claims priority under 35 U.S.C. §119(a) to a Chinese Patent Application filed in the Chinese Intellectual Property Office on Mar. 11, 2011 and assigned Serial No. 201110062112.6, the entire disclosure of which is hereby incorporated by reference.

### TECHNICAL FIELD OF THE INVENTION

The present disclosure relates generally to mobile communication technology, and more particularly to a method for indicating hybrid automatic repeat request timing relation.

### BACKGROUND OF THE INVENTION

In the existing Long Term Evolution (LTE) standard of 3GPP, downlink transmission technique is based on Orthogonal Frequency Division Multiplexing (OFDM), while uplink transmission technique is based on Single Carrier Frequency Division Multiple Access (SCFDMA).

A LTE system includes two types of frame structure, wherein a frame structure of the first type uses Frequency Division Duplex (FDD), and a frame structure of the second type uses Time Division Duplex (TDD). The frame structure of the second type includes seven kinds of frame structure configurations, among which there is a constant ratio from 40% to 90% of downlink subframes, as shown in FIG. 1. As is clearly shown in FIG. 1, each radio frame includes ten (10) radio subframes numbered sequentially from zero (0). Taking the configuration 0 for example:

Subframe 0 and subframe 5 are used for transmitting downlink data. That is, subframe 0 and subframe 5 are used for an evolved NodeB (eNB) to send messages to a User Equipment (UE).

Subframes 2, 3, 4 and subframes 7, 8, 9 are used for transmitting uplink data, namely subframe 2, 3, 4 and subframes 7, 8, 9 are used for UE to send messnes to eNB.

Subframe 1 and subframe 6 are called special subframes, and are formed of three (3) special time slots, which are defined as DwPTS, GP and UpPTS respectively. The time lengths of time slot DwPTS, time slot GP and time slot UpPTS are changeable and the specific values are configured by the system, and a special subframe is used to send downlink data and can be viewed as a shortened downlink subframe.

In an existing TD-LTE system, the frame structure is configured by the eNB half-statically, and is notified to all UEs in the cell periodically via System Information Block 1 (SIB1). The UE determines timing relations of various Hybrid Automatic Repeat request (HARQ) for communicating with the eNB according to current frame structure information broadcast by the eNB. In a LTE system, downlink data HARQ transmission uses asynchronous manner and, in order to reduce cost of information control, uplink data retransmission uses synchronous HARQ manner. The above mentioned HARQ transmission includes three different types of timing relations.

The first kind is the timing relation between an eNB sending downlink data subframe and a UE returning a corresponding ACKnowledgement/Negative ACKnowledgement (ACK/NACK) information subframe during a downlink data asynchronous HARQ transmission.

The second kind is the timing relation between sending a downlink control information subframe containing uplink subframe information and the scheduled uplink frame thereof.

The third kind is the timing relation for the uplink data to synchronize HARQ when a non-adaptive repeat is performed after uplink data receiving is failed, namely, the HARQ timing relation between the uplink data subframe, the ACK/NACK subframe corresponding to this uplink data subframe, and the uplink data retransmission subframe.

In a TD-LTE system, uplink subframes and downlink subframes for different frame structures take different ratios and are put in different positions, so different frame structures configurations correspond to three different timing relations. In an existing TD-LTE system, when traffic volume change leads to the eNB trying to change the frame structure configuration, the eNB uses a paging mechanism to notify the UE in the cell to reread new SIB1 messages, a new frame structure configuration is obtained, and a new timing relation is adopted for HARQ transmission during subsequent communication process. According to current research and measured data in an existing communication system, the uplink/downlink data service requirement changes fast and frequently in certain periods of system operation. With the method of configuring a frame structure half-statically with notification update by paging, it is impossible to dynamically change the uplink/downlink subframe configuration fast and timely according to uplink/downlink data service requirement and notify UE timely to update the timing relation in a HARQ process after the frame structure configuration is changed.

Based on the above analysis, in order to provide a mechanism that can dynamically and timely change the ratio relation between uplink subframes and downlink subframes according to the fast change of uplink/downlink data service, the organization 3GPP launched a new project in the version 11 TD-LTE standard draft, and the object thereof is to design a method for TD-LTE system that can, in real time, track and adjust according to dynamic change of uplink/downlink service requirement the ratio relation of uplink subframes and downlink subframes in a radio frame, and to, in real time, notify the UE of the ratio relation so as to determine the corresponding HARQ timing relation. Based on the above requirement, a frame structure improved from the existing frame structure type 2 based on TD-LTE is provided, as shown in FIG. 2.

In FIG. 2, subframes 3, 4, 7, 8 and 9 are defined as Flexible SubFrame (FlexSF), which are special in that the eNB can dynamically set the FlexSF as uplink subframes or downlink subframes according to service change. As to a Rel-11 UE, unless the UE receives the uplink resource scheduling information sent by the eNB notifying the UE to transmit uplink data via FlexSF, otherwise, the UE will blindly search each FlexSF to obtain the uplink or downlink resource scheduling information sent by the eNB. However, it has become a problem how to timely and dynamically adjust the frame structure setting (namely: change the parameter of FlexSF) according to uplink/downlink data service instant change, and notify the UE of the latest available timing relating while guaranteeing backward compatible equipment to work normally.

### SUMMARY OF THE INVENTION

The present disclosure provides a method for indicating a Hybrid Automatic Repeat Request (HARQ) timing relation, so that after the evolved NodeB (eNB) sets the Flexible SubFrame (FlexSF) dynamically, a Rel-11 UE can timely obtain more available resources and determine available HARQ timing information, and normal communication between a backward compatible user equipment and the eNB can be ensured, so as to reach the object of dynamically and more accurately changing the frame structure according data service change.

A method for indicating HARQ timing relation provided by the present disclosure comprises the following.

A. The eNB notifies the UE to enable uplink/downlink subframe dynamic conversion function.

B. The eNB dynamically updates HARQ timing relation, and notifies the UE of the updated HARQ timing relation.

C. The eNB performs the dynamic subframe conversion corresponding to the updated HARQ timing relation.

D. The eNB and UE communicate with each other in accordance with the updated HARQ timing relation.

As shown by the above mentioned technical scheme, the present disclosure provides a method for indicating a HARQ timing relation in a radio communication system, wherein the eNB notifies the UE in the cell to enable uplink/downlink subframe dynamic conversion function, the eNB converses uplink/downlink subframes dynamically and updates HARQ timing information for UE according to the conversed uplink/downlink subframes, and indicates to the UE of the updated HARQ timing information, so that the Rel-11 UE flexibly uses the subframes with high efficiency, backward compatible user equipment can work normally and efficiently, and finally the whole TD-LTE system can change the frame structure dynamically, more accurately, and timely.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram illustrating the frame structure configuration in an existing TD-LTE system;

FIG. 2 is a diagram illustrating a dynamically changed TD-LTE frame structure;

FIG. 3 is a diagram illustrating a timing sequence of the method for indicating HARQ timing relation provided by the present invention;

FIG. 4 is a diagram illustrating a dynamic transmission of a frame structure configuration information using unused information bit in MIB in a first embodiment of the present invention;

FIG. 5 is a diagram illustrating a format of downlink control information in a second embodiment of the present invention;

FIG. 6 is a diagram illustrating a HARQ timing relation of the downlink data when the backward compatible frame structure is configured as 0 and the eNB adjusts the frame configuration dynamically in a third embodiment of the present invention;

FIG. 7 is a diagram illustrating a HARQ timing relation of the uplink data when the backward compatible frame structure is configured as 0 and the eNB adjusts the frame configuration dynamically in the third embodiment of the present invention;

FIG. 8 is a diagram illustrating a HARQ timing relation of the downlink data when the backward compatible frame structure is configured as 1 and the eNB adjusts the frame configuration dynamically in a fourth embodiment of the present invention;

FIG. 9 is a diagram illustrating a HARQ timing relation of the uplink data when the backward compatible frame structure is configured as 1 and the eNB adjusts the frame configuration dynamically in the fourth embodiment of the present invention;

FIG. 10 is a diagram illustrating, a HARQ timing relation of the downlink data when the backward compatible frame structure is configured as 5 and the eNB adjusts the frame configuration dynamically in the fourth embodiment of the present invention;

FIG. 11 is a diagram illustrating a HARQ timing relation of the uplink data when the backward compatible frame structure is configured as 5 and the eNB adjusts the frame configuration dynamically in the fourth embodiment of the present invention;

FIG. 12 is illustrating the UE apparatus according to an exemplary embodiment of the present invention; and

FIG. 13 is illustrating the eNB apparatus according to an exemplary embodiment of the present invention.

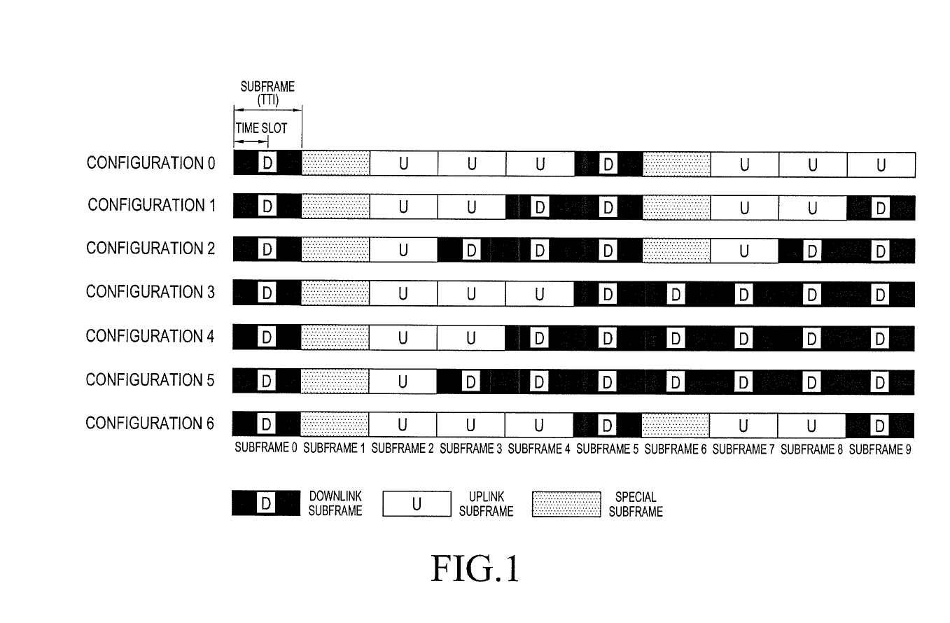

Throughout the drawings, the same drawing reference numerals will be understood to refer to the same elements, features, and structures.

### DETAILED DESCRIPTION OF THE INVENTION

In order to make the objective, technical scheme, and advantages of the present invention clearer and easier to understand, the present invention will be further illustrated in detail with reference to the drawings and embodiments.

According to embodiments of the present invention is: firstly, eNB notifies the User Equipment (UE) to enable the uplink/downlink subframes dynamic conversion function. Then, the eNB dynamically adjusts subframe configuration according to practical demand, and notifies the UE of the HARQ timing relation corresponding to the conversed subframe configuration. Finally, the eNB and UE communicate with each other in accordance with the HARQ timing relation.

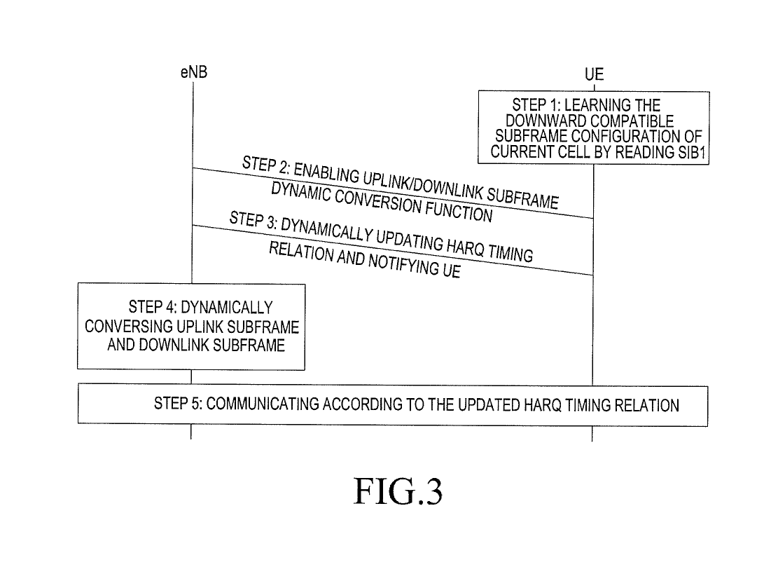

FIG. 3 is a diagram illustrating a timing sequence of the method for indicating HARQ timing relation provided by the present invention. With reference to FIG. 3, the timing sequence includes:

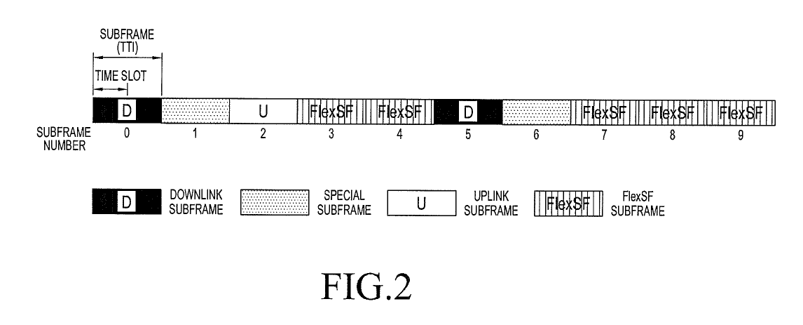

Step 1: The UE learns the backward compatible subframe configuration information of the current cell by reading System Information Block 1 (SIB1). In the following description of the present invention, the frame structure comprising a Flexible SubFrame (FlexSF) shown in FIG. 2 is called a backward compatible frame structure.

Step 2: The eNB notifies the UE to enable the uplink/downlink subframe dynamic conversion function.

Step 3: The eNB dynamically updates HARQ timing relation and notifies the UE of the updated HARQ timing relation.

Step 4: The eNB converses the uplink and downlink subframes, namely: eNB performs dynamic subframe conversion corresponding to the updated HARQ timing relation.

In order to increase resource utilization rate, the eNB may perform dynamic subframe conversion according to the following principles in this step: when it is needed to add uplink subframes, continuous downlink subframes are converted into uplink subframes; when it is needed to add downlink subframes, continuous uplink subframes are converted into downlink subframes.

To convert continuous downlink subframes into uplink subframes, the conversion may follow an order of {f₀, f₁, . . . }, wherein {f₀, f₁, . . . } means: converting subframe f₀ into an uplink subframe first, and then converting subframe f₁ into an uplink subframe, and so on. Specifically speaking:

If the prior-conversion subframe is configured as configuration 2, {f₀, f₁, . . . } is {3,4,8,9} or {8,9,3,4}.

If the prior-conversion subframe is configured as configuration 3, {f₀, f₁, . . . } is {7,8,9}.

If the prior-conversion subframe is configured as configuration 4, {f₀, f₁, . . . } is {4,7,8,9}.

If the prior-conversion subframe is configured as configuration 5, {f₀, f₁, . . . } is {3,4,7,8,9}.

To convert continuous uplink subframes into downlink subframes, the conversion may follow an order of {f₀, f₁, . . . }, wherein {f₀, f₁, . . . } means: converting subframe f₀ into a downlink subframe first, and then converting subframe f₁ into a downlink subframe, and so on. Specifically speaking:

If the prior-conversion subframe is configured as configuration 0, {f₀, f₁, . . . } is {9,8,7,4,3}.

If the prior-conversion subframe is configured as configuration 3, {f₀, f₁, . . . } is {4,3}.

If the prior-conversion subframe is configured as configuration 6, {f₀, f₁, . . . } is {8,7,4,3}.

Step 5: The eNB and the UE communicate with each other in accordance with the updated HARQ timing relation.

As to step 3 of the method shown in step 3, the present invention may be implemented in many ways. For example, seven existing subframe configurations and corresponding HARQ timing relation can still be used, when the subframe configuration has to be adjusted dynamically, the UE is notified of the adopted configuration type via system information or downlink control information, or the UE is notified of the adopted configuration type via a Radio Resource Control (RRC) signaling or a Media Access Control (MAC) signaling, so that the UE may learn the current adopted HARQ timing relation. For another example, a new HARQ timing relation can be predefined based on the prior art, and the eNB notifies the UE of the current adopted HARQ timing relation via downlink control information when the subframe configuration has to be adjusted dynamically. Of course, the present invention may be implemented by combining several ways. Several preferable ways for implementing the present invention will be described in detail hereinafter.

Preferable Way 1:

Predefining HARQ relations corresponding to various subframe configurations. Here, the defined HARQ timing relations include specifically:

the timing relation between the downlink data subframe and corresponding ACK/NAC subframe;

the timing relation between a DCI subframe and the uplink subframe scheduled by the DCI subframe thereof;

the timing relation between uplink data subframe and corresponding ACK/NAK subframe and that between uplink data subframe and uplink data retransmission subframe.

Based on the above predefined HARQ timing relation, in step 3 shown in FIG. 3, the eNB can notify the UE of the updated HARQ timing relation via Downlink Control Information (DCI) when it is required. Here, DCI can be transmitted in specified search space of the UE in a DCI area.

As described above, the present invention relates to predefining, the above mentioned three different types of HARQ timing relations, as will be illustrated in detail hereinafter.

The first kind of HARQ timing relation is the timing relation between a downlink data subframe and corresponding ACK/NACK subframe.

The first kind of HARQ timing relation is denoted as {n,k₀,k₁} in the present invention, wherein, k₀ and k₁ are both greater than or equal to 4.

{n,k₀,k₁} includes two kinds of timing relations, wherein:

the first kind of timing, relation is: when subframe n is used to transmit downlink data, the k₀ₜₕ subframe after subframe n is used to transmit the corresponding ACK/NACK information;

the second kind of timing relation is: when subframe n is used to transmit downlink data, the k₁ₜₕ subframe after subframe n is used to transmit the corresponding ACK/NACK information.

Based on the above predefined timing relation {n,k₀,k₁}, the eNB can notify the UE via timing information field in DCI information to take one of the above mentioned two timing relations as the timing relation between current downlink data subframe and the corresponding ACK/NACK subframe. Preferably, the bit number of the timing information field can take 1 bit or 2 bits.

If the timing information field takes 1 bit, different values of this one bit may correspond to the above mentioned two timing relations. For example, symbol b₀ signifies a timing information field, and it's appointed that: b₀=0 means taking the above mentioned first kind of timing relation as that between current downlink data subframe and corresponding ACK/NACK subframe, while b₀=1 means taking the above mentioned second kind of timing relation as that between current downlink data subframe and corresponding ACK/NACK subframe.

With this way, the eNB may statically configure an ACK/NACK channel for each UE in advance; when the UE receives downlink control information in a downlink subframe and value of timing information field in this downlink control information indicates the UE to use the above second timing relation as that between current downlink data subframe and corresponding ACK/NACK subframe, the UE uses the ACK/NACK channel statically configured by the eNB to transmit ACK/NACK information in accordance with subframe n.

If the timing information field takes 2 bits, one of the 2 bits can be taken as the timing information bit, which is assigned with different values corresponding to the above mentioned two timing relations. For example, symbol b₀ signifies the timing information field, and it's appointed that: b₀=0 means taking the above mentioned first kind of timing relation as that between the current downlink data subframe and the corresponding ACK/NACK subframe, while b₀=1 means taking the above mentioned second kind of timing relation as that between the current downlink data subframe and the corresponding ACK/NACK subframe.

With this way, eNB may statically configure a group of ACK/NACK channels for a group of UEs in advance, and 4 values of the 2 bits corresponds to each of the said group of ACK/NACK channels respectively. When the UE receives downlink control information in a downlink subframe and the value of the timing information field in this downlink control information indicates the UE to use the above second timing relation as that between the current downlink data subframe and the corresponding ACK/NACK subframe, the UE uses the ACK/NACK channel statically configured by the eNB to transmit ACK/NACK information in accordance with subframe n.

Preferably, the timing relation {n,k₀,k₁} can be defined in the following way:

Corresponding to configuration 0, the timing relation {n,k₀,k₁} is {0,4,12}, {1,6,11}, {3,9,9}, {4,9,8}, {5,4,7}, {6,6,6}, {7,6,5}, {8,5,4}, {9,4,13}, as shown in table 1:

TABLE 1

| Downlink | | | | | | | | | | |
|---|---|---|---|---|---|---|---|---|---|---|
| subframe | Subframe number i | | | | | | | | | |
| ratio p | 0 | 1 | 2 | 3 | 4 | 5 | 6 | 7 | 8 | 9 |
| 40% | | | 6 | | 4 | | | 6 | | 4 |
| 50% | | | 6, 7 | 4 | 4 | | | 6 | | |
| 60% | | | 6, 7 | 4, 5 | 4 | | | 6 | | |
| 70% | | | 6, 7, 11 | 4, 5, 6 | 4 | | | | | |
| 80% | | | 6, 7, 11, 12 | 4, 5, 6, | | | | | | |
| | | | | 9 | | | | | | |
| 90% | | | 6, 7, 11, 12, | | | | | | | |
| | | | 13, 9, 5, 4 | | | | | | | |

The physical meaning of Table 1 is as follows. When the downlink subframes ratio is p, ACK/NACK information carried on the i^{th} uplink subframe corresponds to data received by the downlink subframe with an interval of k−1 ahead, as to different subframe number i and downlink subframe ratio p, the value of k is as shown in Table 1.

Corresponding to row 1 in Table 1, namely frame structure configuration 0, p=40%, ACK/NACK information carried on the second subframe corresponds to data received by the downlink subframe with an interval of 5 ahead, namely the ACK/NACK carried on the second subframe corresponds to downlink data received by subframe 6 in the previous radio frame (the subframes are numbered from 0). In the same way, according to table 1, the ACK/NACK information carried on the fourth subframe corresponds to data received by the downlink subframe with an interval of 3 ahead, namely ACK/NACK information corresponding to downlink data received by subframe 0 in the same radio frame is transmitted on subframe 4. It can be deduced in the same way that downlink subframes corresponding to ACK/NACK information carried on the seventh subframe and the ninth subframe are subframe 1 and subframe 5 in the same radio frame respectively.

Corresponding to row 2 in table 1, p. 50%. According to values in the table 1, ACK/NACK information carried on subframe 2 corresponds to data received by the two downlink subframes with an interval of 5 and 6, namely ACK/NACK information corresponding to downlink data received by subframe 5 and subframe 6 in a radio frame is transmitted on subframe 2, and it can be deduced what other values mean in the same way.

The physical meanings of table 2 to table 7 are the same as that of table 1, which is not to be illustrated here.

Corresponding to configuration 1, the said {n,k₀,k₁} is: {0,7,12}, {1,6,11}, {3,4,9}, {4,4,8}, {5,7,7}, {6,6,6}, {7,5,5}, {8,5,4}, {9,4,13}, as shown in table 2:

TABLE 2

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 7, 6 | | | | | 7, 6 | | |
| 50% | | | 7, 6 | 4 | | | | 7, 6 | | |
| 60% | | | 7, 6 | 4 | | | | 7, 6 | 4 | |
| 70% | | | 7, 6, 8 | 4, | | | | 7, 6 | | |
| | | | | 5 | | | | | | |
| 80% | | | 7, 6, 8, 13, 4 | | | | | 7, 6, | | |
| | | | | | | | | 4 | | |
| 90% | | | 7, 6, 8, 13, | | | | | | | |
| | | | 4, 12, 9, 5, 11 | | | | | | | |

Corresponding to configuration 2, timing relation {n,k₀,k₁} is: {0,7,12}, {1,6,11}, {3,4,9}, {4,8,8}, {5,7,7}, {6,6,6}, {7,5,5}, {8,4,4}, {9,8,13}, as shown in table 3:

TABLE 3

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 7, 6 | | | | | 7, 6 | | |
| 50% | | | 7, 6 | | | | | 8, 7, 6 | | |
| 60% | | | 7, 4, 6 | | | | | 8, 7, 6 | | |
| 70% | | | 7, 4, 6 | | | | | 8, 7, 6, 4 | | |
| 80% | | | 8, 7, 4, 6 | | | | | 8, 7, 6, 4 | | |
| 90% | | | 8, 7, 4, 6, 13, 12, 9, 5, 11 | | | | | | | |

Corresponding to configuration 3, timing relation {n,k₀,k₁} is: {0,4,12}, {1,11,11}, {3,9,9}, {4,9,8}, {5,7,7}, {6,6,6}, {7,6,5}, {8,5,4}, {9,5,13}, as shown in table 4:

TABLE 4

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 7, 6, 11 | | 4 | | | | | |
| 50% | | | 7, 6, 11 | | 5, 4 | | | | | |
| 60% | | | 7, 6, 11 | 5 | 5, 4 | | | | | |
| 70% | | | 7, 6, 11 | 6, 5 | 5, 4 | | | | | |
| 80% | | | 7, 6, 11, 13, 12 | 6, 5, 9 | | | | | | |
| 90% | | | 7, 6, 11, 13, 12, 8, 9, 5, 4 | | | | | | | |

Corresponding to configuration 4, timing relation {n,k₀,k₁} is: {0,12,12}, {1,11,11}, {3,9,9}, {4,8,8}, {5,7, 7}, {6,7,6}, {7,6,5}, {8,5,4}, {9,4,13}, as shown in table 5:

TABLE 5

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 12, 7, 11 | 7 | | | | | | |
| 50% | | | 12, 7, 11 | 4, 7 | | | | | | |
| 60% | | | 12, 7, 11 | 5, 4, 7 | | | | | | |
| 70% | | | 12, 7, 11 | 6, 5, 4, 7 | | | | | | |
| 80% | | | 12, 8, 7, 11 | 6, 5, 4, 7 | | | | | | |
| 90% | | | 12, 8, 7, 11, 13, 9, 5, 4, 6 | | | | | | | |

Corresponding to configuration 5, timing relation {n,k₀,k₁} is: {0,12,4}, {1,11,6}, {3,9,9}, {4,8,8}, {5,7,4}, {6,6,6}, {7,5,5}, {8,4,4}, {9,13,4}, as shown in table 6:

TABLE 6

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 6 | | 4 | | | 6 | | 4 |
| 50% | | | 7, 6 | 4 | 4 | | | 6 | | |
| 60% | | | 7, 6, 4 | 4 | 4 | | | 6 | | |
| 70% | | | 11, 7, 6, 5, 4 | 4 | 4 | | | | | |
| 80% | | | 12, 11, 8, 7, | 4 | | | | | | |
| | | | 6, 5, 4 | | | | | | | |
| 90% | | | 13, 12, 9, 8, 7, 5, | | | | | | | |
| | | | 4, 11, 6 | | | | | | | |

Corresponding to configuration 6, timing relation {n,k₀,k₁} is: {0,7,12}, {1,7,11}, {3,9,9}, {4,9,8}, {5,7,7}, {6,7,6}, {7,6,5}, {8,5,4}, {9,5,13}, as shown in table 7:

TABLE 7

| Downlink | | | | | | | | | | |
|---|---|---|---|---|---|---|---|---|---|---|
| subframe | Subframe number i | | | | | | | | | |
| ratio | 0 | 1 | 2 | 3 | 4 | 5 | 6 | 7 | 8 | 9 |
| 40% | | | 7 | 7 | | | | 7 | 7 | |
| 50% | | | 7 | 7 | 5 | | | 7 | 7 | |
| 60% | | | 7, 11 | 7, 5 | 5 | | | 7 | | |
| 70% | | | 7, 11, 12 | 7, 5, 6 | | | | | | |
| 80% | | | 7, 11, 12, 13 | 7, 5, | | | | | | |
| | | | | 6, 9 | | | | | | |
| 90% | | | 7, 11, 12, | | | | | | | |
| | | | 13, 9, 8, 6, | | | | | | | |
| | | | 5, 4 | | | | | | | |

The second kind of HARQ timing relation is the timing relation between DCI subframe and the uplink subframe scheduled by the DCI subframe thereof.

As to the second kind of HARQ timing relation, two candidate subframe positions are predefined for each DCI subframe comprising an uplink resource scheduling indicator for uplink data transmission, and this timing relation is signified with symbol {m,g}.

The {m,g} includes two kinds of timing relations, wherein:

The first kind of timing relation is, when DCI information transmitted on subframe m includes an uplink resource scheduling indicator, the scheduled uplink subframe is the first of the two continuous subframes starting from the g^{th} subframe after subframe m.

The second kind of timing relation is, when DCI information transmitted on subframe m includes an uplink resource scheduling indicator, the scheduled uplink subframe is the second of the two continuous subframes starting from the g^{th} subframe after subframe m.

Therein, both of the said two subframes belong to subframe set of {2,3,4,7,8,9}, and g is greater than or equal to 4.

Based on the above predefined timing relation {m,g}, the eNB can notify the UE via the uplink subframe index field in the DCI transmitted on subframe m to take one of the above-mentioned two timing relations as the timing relation between the current downlink control information subframe and the uplink subframe scheduled by this downlink control information subframe. Here, the uplink subframe index field takes 2 bits signified as c₀c₁; c₀c₁=01 means using the said first kind of timing relation as the timing relation between the current downlink control information subframe and the uplink subframe scheduled by this downlink control information subframe, while c₀c₁=10 means using the said second kind of timing relation as the timing relation between the current downlink control information subframe and the uplink subframe scheduled by this downlink control information subframe.

Preferably, the timing relation {m,g} is:

{0,4}, {1,6}, {3,4}, {4,4}, {5,4}, {6,6}, {8,4}, {9,4}.

The third kind of HARQ timing relation is the timing relation between the uplink data subframe and the corresponding ACK/NACK subframe as well as uplink data retransmission subframe.

The third kind of HARQ timing relation is {l,p₀,r₀,p₁,r₁} signified as in the present invention.

{l,p0,r0,p1,r1} includes two kinds of timing relations, wherein:

The first kind of timing relation is, when subframe 1 is used to transmit uplink data, the p₀ₜₕ subframe after subframe 1 is used to transmit corresponding ACK/NACK information, and the (p₀ r₀)ₜₕ subframe after subframe 1 is used for uplink data retransmission.

The second kind of timing relation is, when subframe 1 is used to transmit uplink data, the p₁ₜₕ subframe after subframe 1 is used to transmit corresponding ACK/NACK information, and the (p₁+r₁)ₜₕ subframe after subframe 1 is used for uplink data retransmission.

Based on the above predefined timing relation {l,p₀,r₀,p₁r₁}, the eNB can notify the UE via the timing information field in the DCI to take one of the above-mentioned two timing relations as the timing relation between the current uplink data subframe and the corresponding ACK/NACK subframe as well as uplink data retransmission subframe. Here, the timing information field takes 1 bit, and different values of this 1 bit correspond to two kinds of timing relations respectively. For example, symbol b₀ signifies the timing information field, and it's appointed that: b₀=0 means taking the above-mentioned first kind of timing relation as that between the current uplink data subframe and the corresponding ACK/NACK subframe as well as uplink data retransmission subframe, while b₀=1 means taking the above-mentioned second kind of timing relation as that between the current uplink data subframe and the corresponding ACK/NACK subframe as well as uplink data retransmission subframe.

Preferably, timing relation {l,p₀,r₀,p₁r₁} can be defined in the following manner.

Corresponding to configuration 0, timing relation {l,p₀,r₀,p₁r₁} is: {2,4,7,4,6}, {3,7,4,5,4}, {4,6,7,4,4}, {7,4,7,8,7}, {8,7,4,7,7}, {9,6,7,6,7}.

Corresponding to configuration 1, timing relation {l,p₀,r₀,p₁r₁} is: {2,4,6,4,6}, {3,6,4,13,7}, {4,6,4,6,4}, {7,4,6,4,6}, {8,6,4,13,7}, {9,6,4,6,4}.

Corresponding to configuration 2, timing relation {l,p₀,r₀,p₁,r₁} is: {2,6,4,4,6}, {3,6,4,13,7}, {4,6,4,6,4}, {7,6,4,4,6}, {8,13,7,13,7}, {9,6,4,6,4}

Corresponding to configuration 3, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4}.

Corresponding to configuration 4, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4}.

Corresponding to configuration 5, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4}.

Corresponding to configuration 6, timing relation {l,p₀,r₀,p₁,r₁} is: {2,4,7,6,4}, {3,6,5,7,4}, {4,6,7,4,4}, {7,4,7,8,7}, {8,7,7,7,7}, {9,6,4,6,4}.

Preferable Way 2:

The eNB notifies the UE of the system information reading period first. Then, within the time corresponding to the system information reading period, the eNB sends a piece of system information carrying subframe configuration information corresponding, to the updated HARQ timing relation to the UE, so that the UE learns the subframe configuration information in this system information, and the current used HARQ timing relation is determined according, to the subframe configuration information.

For specific implementations, corresponding relations between the bit values and configuration 0˜6 can be preset, so that the eNB can use the 3 unused bits in system information and, according to this preset corresponding relation, the 3 bits are filled with bit values corresponding to the dynamically conversed subframe configurations, so that the UE can learn the dynamically conversed subframe configuration and determine the corresponding HARQ timing relation.

The available system information includes main information block and/or system information block 1.

Preferable Way 3:

The corresponding relation between bit values and configuration 0˜6 are preset, a 3-bit timing information field is carried in downlink control information by the eNB, according to this preset corresponding relation, and timing information field is filled with bit values corresponding to the dynamically conversed subframe configuration, so that the UE can learn the dynamically conversed subframe configuration and determine the corresponding HARQ timing relation.

Preferable Way 4:

The eNB uses Radio Resource Control (RRC) signaling or Media Access Control (MAC) signaling to notify the UE in the cell of the latest subframe configuration. For example, the corresponding relation between bit values and configuration 0˜6 can be preset, and a 3-bit information is carried in the RRC signaling or MAC signaling sent to the UE, according to the preset corresponding relation. The 3 bits in the RRC signaling or MAC signaling are filled with bit values corresponding to the subframe configuration corresponding to the updated HARQ timing relation.

The present invention will be illustrated in detail hereinafter with reference to five embodiments.

### Embodiment 1

In the present embodiment, it is assumed that the backward compatible frame structure of the cell in a TD-LTE system is initially configured as configuration 1, downlink data service rises dramatically while uplink data service decreases 100 ms later, so the eNB adjusts the subframe structure dynamically as configuration 5, so as to provide more downlink data resources.

According to the present invention, the following method can be adopted to dynamically change uplink/downlink frame structure configurations and notify the UE of the said configuration:

It is assumed that the system's available system information reading period is configured as (T₀, T₁, . . . , Tₙ). In the present embodiment, it is assumed that (T₀, T₁, . . . , Tₙ) is (40 ms, 80 ms, 120 ms, 160 ms, 320 ms), n=4, and the eNB determines that reading period of system information is 80 ms according to current data service change.

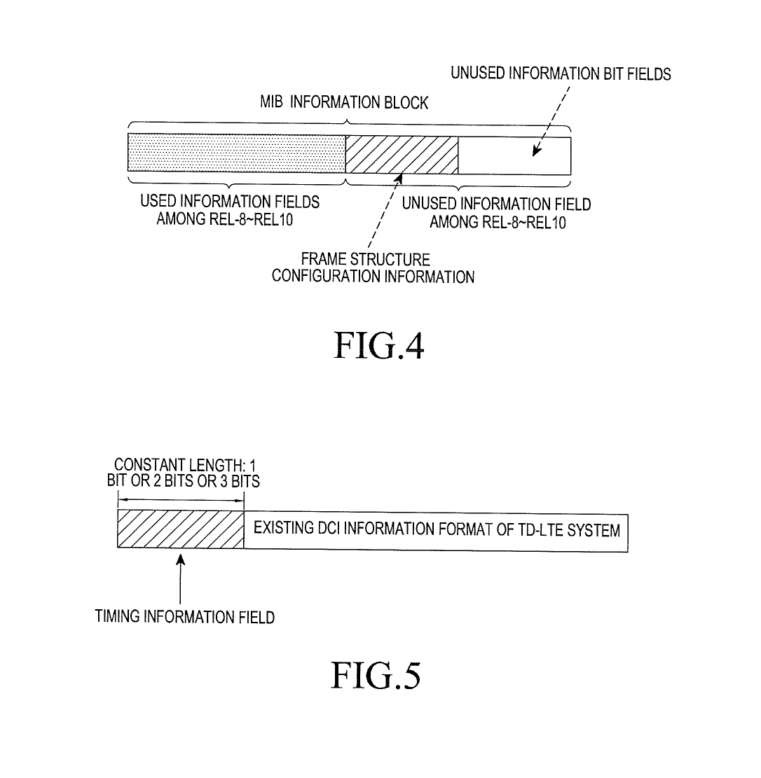

The eNB notifies the UE system of current frame structure configuration using the three unused information bits in Main Information Block (MIB), as shown in FIG. 4. Physical meaning of the 3-bit frame structure configuration is as follows: ‘000’ represents configuration 0, ‘001’ represents configuration 1, ‘010’ represents configuration 2, ‘011’ represents configuration 3, ‘100’ represents configuration 4, ‘101’ represents configuration 5, ‘110’ represents configuration 6, and ‘111’ is reserved for subsequent version use.

Based on the above assumption, the present embodiment is implemented by the following method:

Step 1: The eNB notifies the Rel-11 UE in the cell via the broadcast RRC signaling that system information reading period is T₁=80 ms.

Step 2: When the eNB transmits an MIB message in the Physical Broadcast Channel (PBCH) resource after the 160^{th} ms, the subframe configuration information bit in the MIB message is changed from ‘001’ to ‘101’, and subframes 3, 7 and 8 are dynamically configured as downlink subframes.

Step 3: After the 160^{th} ms, the UE learns that the current frame structure configuration is configuration 5 by reading the subframe configuration information bit in the MIB, and the UE communicates with the eNB according to the HARQ timing relation of configuration 5.

### Embodiment 2

In the present embodiment, it is assumed that the backward compatible frame structure is initially configured as configuration 2, uplink data service rises dramatically while downlink data service decreases 100 ms later, so the eNB adjusts the subframe structure dynamically as configuration 0, so as to provide more uplink data resources. In the present embodiment, the eNB notifies the UE of the frame structure configuration change and new HARQ timing relation by sending a new Downlink Control Information (DCI) format.

Therein, the new DCI format includes two parts. The first part is the timing information field, by which the eNB notifies the UE of the latest frame structure configuration information. The second part is the existing extendable DCI information field in a LTE system. The position of the timing information field is determined, which is at the front or the end of the existing DCI information field. In the present embodiment, the timing information field is located at the front of DCI information field, as shown in FIG. 5. A new DCI information is only transmitted in specified search space of the UE in the DCI area.

In the present embodiment, the physical meaning of the three bits in timing information field is defined as follows: ‘000’ represents configuration 0, ‘001’ represents configuration 1, ‘010’ represents configuration 2, ‘011’ represents configuration 3, ‘100’ represents configuration 4, ‘101’ represents configuration 5, ‘110’ represents configuration 6, and ‘111’ is reserved for subsequent version use.

The method for indication HARQ timing relation in the present disclosure includes:

Step 1: The eNB notifies the UE in the cell via the broadcast RRC signaling or the specified RRC signaling to enable uplink/downlink subframe dynamic conversion function.

Step 2: 100 ms later, the eNB detects that uplink data service rises so dramatically that the subframe configuration has to be changed to configuration 0 dynamically, and the eNB changes the timing information field thereof from ‘010’ to ‘000’ when transmitting DCI information for uplink/downlink resource scheduling.

Step 3: The UE reads the timing information field in the received DCI information and learns that the frame configuration of the cell has been changed to configuration 0, and then communicates with the eNB according to existing HARQ timing relation and ACK/NACK mapping method of configuration 0.

### Embodiment 3

It is assumed that the frame structure configuration of the system is configuration k, and it is assumed that k=0 in the present embodiment, namely the ratio of downlink data subframes (including the special subframe) is 40%. The eNB dynamically adjusts the ratio of downlink subframes in a radio frame according to data service change. It is assumed in the present embodiment that the eNB increases the ratio of downlink subframes from 40% to 80% due to the rise of downlink data service, so as to provide more downlink resources for downlink data transmission. The timing information field has m (1≦m≦3) bits in the new DCI, and m=1 in the present embodiment.

The method for indicating HARQ timing relation in the present embodiment includes the following steps:

Step 1: predefining the HARQ timing relation.

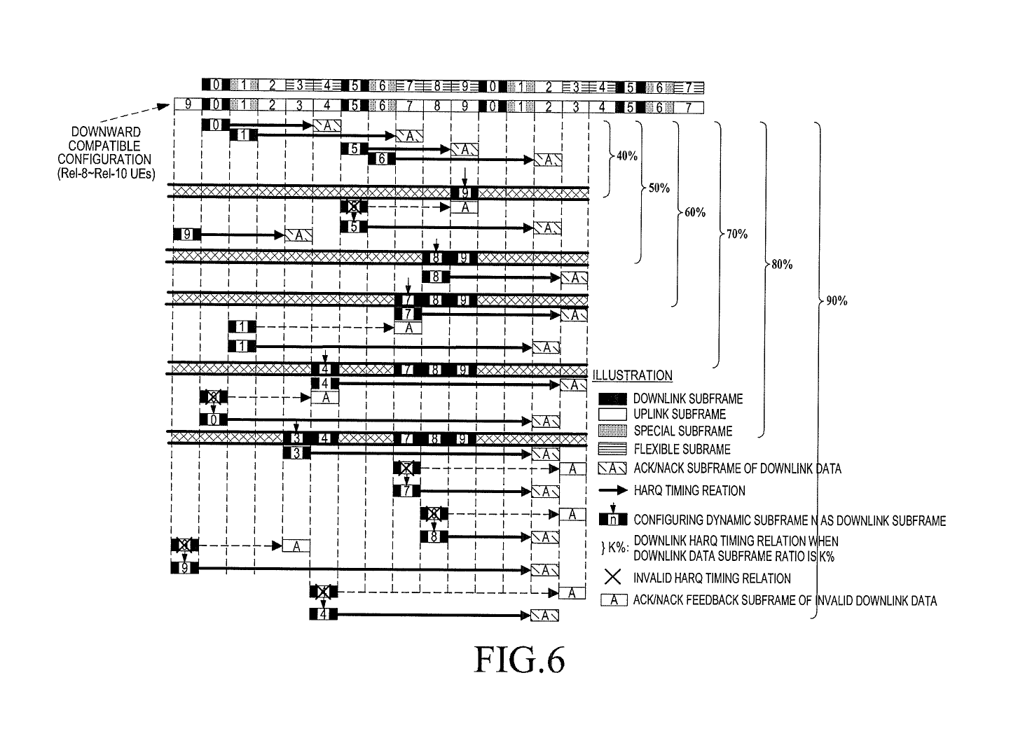

According to the backward compatible frame structure configuration, one or two subframe positions are predefined for each downlink data subframe for transmitting corresponding ACK/NACK information, and symbol {n,k₀,k₁} signifies the timing relation among subframes. The physical meaning of {n,k₀,k₁} is: corresponding to the downlink data transmitted on the subframe numbered n, the position of the first subframe for transmitting ACK/NACK information is the k₀ₜₕ subframe after subframe n, while the position of the second subframe for transmitting ACK/NACK information is the k₁ₜₕ subframe after subframe n, wherein k₀,k₁ are both greater than or equal to 4. In the present embodiment, when the backward compatible frame structure configuration is configuration 0, the predefined timing relation {n,k₀,k₁} is {0,4,12}, {1,6,11}, {3,9,9}, {4,9,8}, {5,4,7}, {6,6,6}, {7,6,5}, {8,5,4}, {9,4,13}, as shown in FIG. 6.

According to the backward compatible frame structure configuration, two types of timing relations are predefined for each uplink subframe.

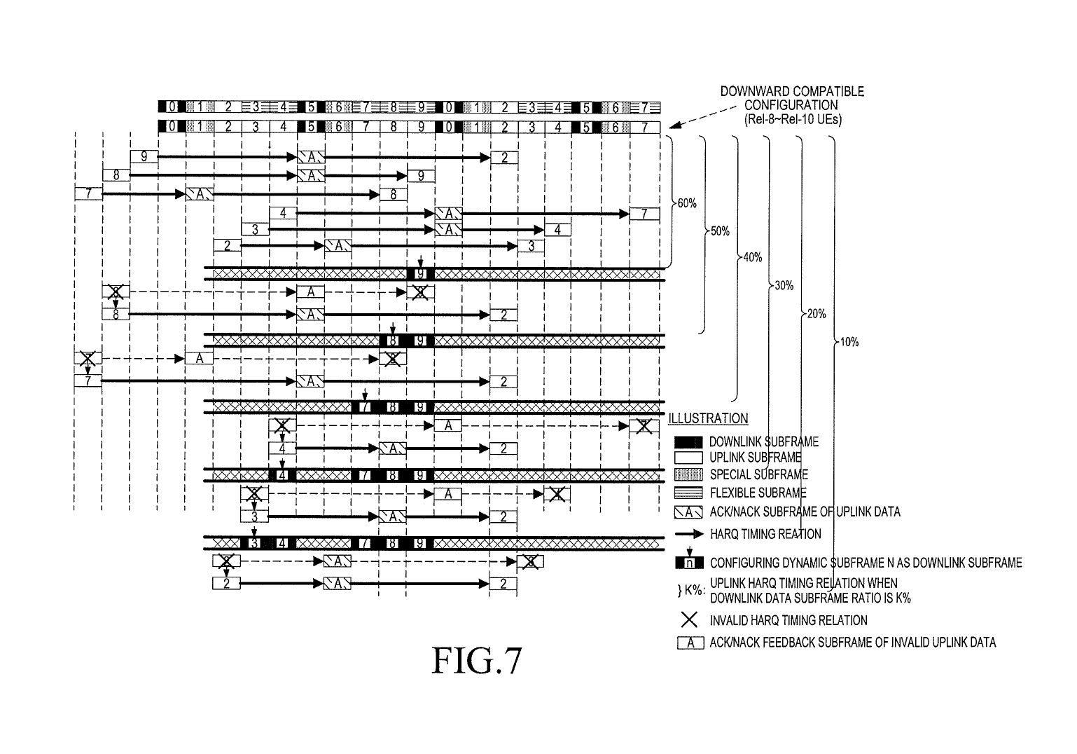

The first type of timing relation is the timing relation between the DCI subframe and the scheduled uplink subframe thereof, as shown in FIG. 7. Two subframe positions are predefined for each downlink control information comprising an uplink resource indicator for uplink data transmission, and are signified as {m,g}. The physical meaning of {m,g} is: m is the number of the subframe on which the downlink control information is transmitted, and the scheduled uplink data subframes thereof are two continuous subframes starting from the g^{th} subframe after subframe m, and both of the two continuous subframes belong to the set {2,3,4,7,8,9}. The specific subframe number is determined by the uplink subframe index field (UL index) in the downlink control information allocated by uplink resources. Therein, m=0, 1, . . . 9 denotes the subframe number in a single radio frame, g is greater than or equal to 4, the meaning of UL index is the same as that of existing LTE system when the configuration is configuration 0. Namely, if the bits in UL index are set as c₀c₁=01, the first of the two continuous subframes is used to transmit uplink data, and if the bits in UL index are set as c₀c₁=10, the second of the two continuous subframes is used to transmit uplink data. Therein c₀ denotes the Least Significant Bit (LSB) of UL index, while c₁ denotes the Most Significant Bit (MSB) of UL index. More specifically, in the present embodiment, the first kind of timing relation {m,g} is: {0,4}, {1,6}, {3,4}, {4,4}, {5,4}, {6,6}, {8,4}, {9,4}.

The second kind of timing relation is that between the uplink data subframe and the corresponding ACK/NACK subframe as well as the uplink data retransmission subframe, still as shown in FIG. 7. At most two different HARQ timing relations are predefined for each uplink subframe, denoted as {l,p₀,r₀,p₁,r₁}. Therein, {l,p₀,r₀} is used to determine the first HARQ timing relation, while {l,p₁,r₁} is used to determine the second HARQ timing relation, and the physical meaning is: l denotes the number of the subframe for transmitting uplink data; pᵢ is used to calculate the position of the ACK/NACK subframe corresponding to uplink data, and the specific calculating method is that the corresponding ACK/NACK subframe is the pᵢ_{ₜₕ} subframe after uplink subframe l; rᵢ is used to calculate the position of the uplink data retransmission subframe, and the specific calculating method is that the (pᵢ+rᵢ)ₜₕ subframe after subframe/is used for uplink data retransmission, wherein i=0,1. Specifically speaking, the second kind of timing relation {l,p₀,r₀,p₁,r₁} is: {2,4,7,4,6}, {3,7,4,5,4}, {4,6,7,4,4}, {7,4,7,8,7}, {8,7,4,7,7}, {9,6,7,6,7}.

Step 2: The eNB notifies the Rel-11 UE in the cell to enable uplink/downlink subframe dynamic conversion function by broadcasting RRC signaling within the entire network or by using a special RRC signaling.

Step 3: Unless assured uplink resource scheduling information is received indicating the UE to transmit uplink data on a certain flexible subframe, Rel-11 UE blindly searches each FlexSF for downlink control information, and it is assumed that downlink control information comprises a new 1-bit timing information field.

Step 4: The eNB sets flexible subframes 4, 7, 8 and 9 as downlink subframes according to the method of {f₀,f₁,f₂,f₃}={9,8,7,4} in order to increase the downlink subframe ratio to 80%, and allocates a half-static ACK/NACK channel (denoted as Hₛ) for each Rel-11 UE, wherein Hₛ can be used by a single UE exclusively or be shared by a plurality of UEs. When the eNB transmits downlink control information, according to subframe numbers and downlink control information type, the timing information field is set as follows.

If the downlink control information includes a downlink resource allocation indicator, in subframe 0, 1 and 5, the timing information field is set as “b₀=1” in downlink control information that downlink resource allocation indicates, so as to indicate to the UE to feed back ACK/NACK using the second uplink subframe position corresponding to downlink data subframe described in step 1. In subframe 4, 6, 7, 8 and 9, the timing information field is set as “b₀=0” in the downlink control information that downlink resource allocation indicates, so as to indicate the UE to feed back ACK/NACK using the first uplink subframe position corresponding, to downlink data subframe described in step 1.

If the downlink control information comprises an uplink resource allocation indicator, when the downlink control information indicated by the uplink resource allocation is transmitted on subframe 6 and subframe 8, the uplink subframe index field in the downlink control information in subframe 6 is set as “c₀c₁=10” and bits in the timing information field are all set as “b₀=0”, while the uplink subframe index field in downlink control information in subframe 8 is set as “c₀c₁=01”, and bits in the timing information field are all set as “b₀=1”, wherein “c₀” denotes the Least Significant Bit (LSB) of uplink subframe index field, while “c₁” denotes the Most Significant Bit (MSB) of uplink subframe index field.

Step 5: The UE determines the corresponding timing relation to communicate with the eNB according to value of timing information field bit “b₀” in downlink control information received by different downlink subframes.

Specifically speaking, if downlink control information indicated by downlink resource allocation is received in subframe 0, 1 and 5, since “b₀=1” in timing information field, position of the second uplink subframe in corresponding downlink data subframe in step 1 is adopted to feed back ACK/NACK. As shown in FIG. 6 in the present embodiment, when the above mentioned downlink control information is received in subframe 0, 1 and 5, the UE feeds back ACK/NACK on subframe 2 using the statically allocated ACK/NACK channel resource Hₛ; when downlink control information is detected in subframe 4, 6, 7, 8 and 9, exiting LTE timing relation of configuration 0 is maintained.

When the UE detects that subframe 6 comprises downlink control information allocated by uplink resource, since uplink subframe index field of downlink control information is set as “c₀c₁=10”, the UE transmits uplink data on subframe 3 of the next radio frame, when data non-adaptive repeat happens, since timing information field of downlink control information is set as “b₀=0”, the UE adopts the first HARQ timing relation {2,4,7} and {3,7,4} for data retransmission; when downlink control information allocated by uplink resource is detected in subframe 8, since uplink subframe index field of downlink control information is set as “c₀c₁=01”, the UE transmits uplink data on subframe 2 of the next radio frame, when data non-adaptive repeat happens, since timing information field of downlink control information is set as “b₀=1”, the UE adopts the first HARQ timing relation {3,5,4} and {2,4,7} for data retransmission.

### Embodiment 4

It is assumed that the frame structure configuration of the system is configuration k, and it is assumed that k=1 in the present embodiment, namely the ratio of downlink data subframes (including, the special subframe) is 60%. The eNB dynamically adjusts the ratio of downlink subframes in a radio frame according to data service change. It is assumed in the present embodiment that the eNB increases ratio of downlink subframes from 60% to 80% due to rise of downlink data service, so as to provide more downlink resources for downlink data transmission. The timing information field has m(1≦m≦3) bits in the new DCI, and m=1 in the present embodiment.

The method for indicating HARQ timing relation in the present embodiment includes the following steps:

Step 1: predefining the HARQ timing relation.

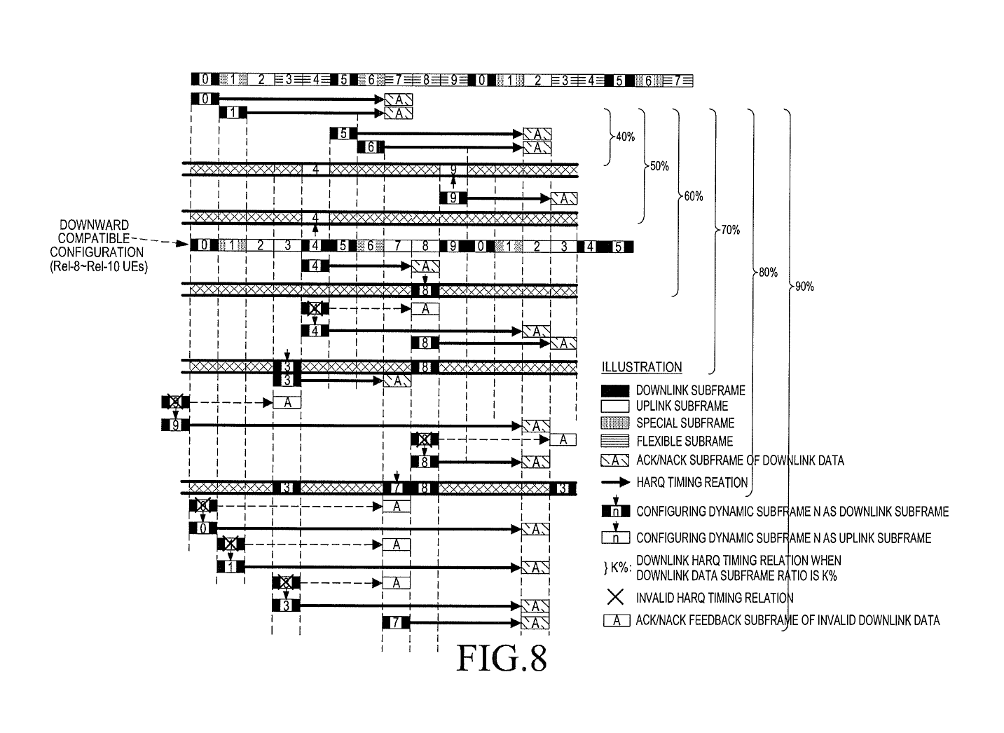

According to the backward compatible frame structure configuration, one or two subframe positions are predefined for each downlink data subframe for transmitting corresponding ACK/NACK information, and symbol {n,k₀,k₁} signifies the timing relation among subframes. The physical meaning of {n,k₀,k₁} is: corresponding to the downlink data transmitted on the subframe numbered n, the position of the first subframe for transmitting ACK/NACK information is the k₀ₜₕ subframe after subframe n, while the position of the second subframe for transmitting ACK/NACK information is the k₁ₜₕ subframe after subframe n, wherein k₀,k₁ are both greater than or equal to 4. In the present embodiment, when the backward compatible frame structure configuration is configuration 1, the predefined timing relation {n,k₀,k₁} is {0,7,12}, {1,6,11}, {3,4,9}, {4,4,8}, {5,7,7}, {6,6,6}, {7,5,5}, {8,5,4}, {9,4,13}, as shown in FIG. 8.

According to the backward compatible frame structure configuration, two types of timing relations are predefined for each uplink subframe:

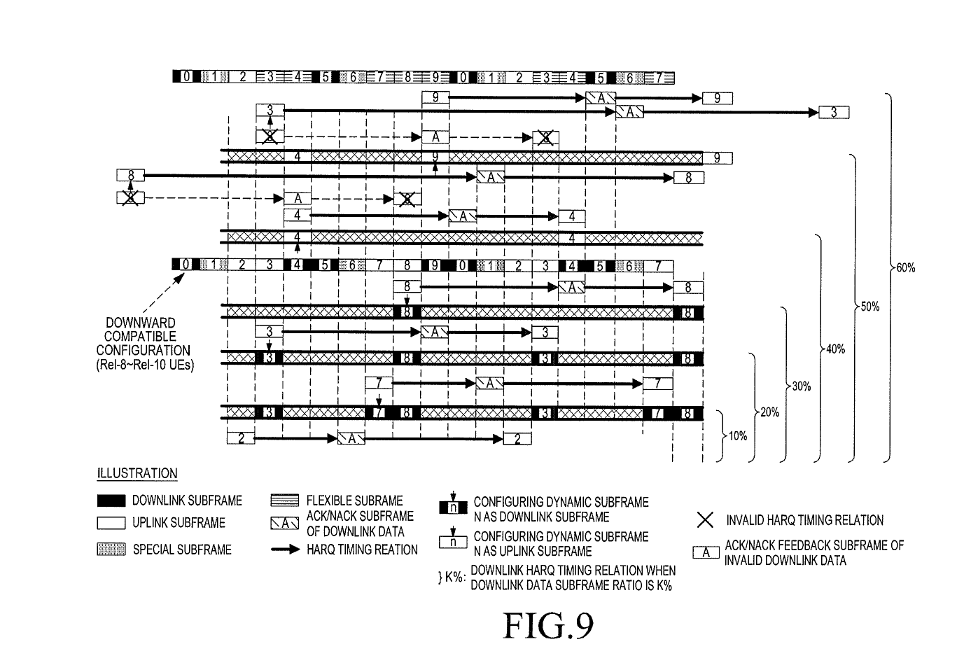

The first kind of timing relation is the timing relation between the DCI subframe and the scheduled uplink subframe thereof, as shown in FIG. 9. Two subframe positions are predefined for each downlink control information comprising an uplink resource indicator for uplink data transmission, and are signified as {m,g}. The physical meaning of {m,g} is: m is number of the subframe on which downlink control information is transmitted, and the scheduled uplink data subframes thereof are two continuous subframes starting from the g^{th} subframe after subframe m, and both of the two continuous subframes belong to the set {2,3,4,7,8,9}. The specific subframe number is determined by the uplink subframe index field (UL index) in the downlink control information allocated by uplink resources. Therein, m=0, 1, . . . 9 denotes the subframe number in a single radio frame, g is greater than or equal to 4, the meaning of the UL index is the same as that of existing LTE system when the configuration is configuration 0, namely, if bits in UL index are set as c₀c₁=01, the first of the two continuous subframes is used to transmit uplink data, and if bits in UL index are set as c₀c₁=10, the second of the two continuous subframes is used to transmit uplink data. Therein, c₀ denotes the Least Significant Bit (LSB) of the UL index, while c₁ denotes the Most Significant Bit (MSB) of the UL index. More specifically, in the present embodiment, the first type of timing relation {m,g} is: {0,4}, {1,6}, {3,4}, {4,4}, {5,4}, {6,6}, {8,4}, {9,4}.

The second kind of timing relation is that between the uplink data subframe and the corresponding ACK/NACK subframe as well as uplink data retransmission subframe, still as shown in FIG. 9. At most, two different HARQ timing relations are predefined for each uplink subframe, denoted as {l,p₀,r₀,p₁,r₁}. Therein, {l,p₀,r₀} is used to calculate the first HARQ timing relation, while {l,p₁,r₁} is used to calculate the second HARQ timing relation, and the physical meaning is: l denotes the number of the subframe for transmitting uplink data, pᵢ is used to calculate position of the ACK/NACK subframe corresponding to uplink data, and the specific calculating method is that the said corresponding ACK/NACK subframe is the pᵢth subframe after the uplink subframe 1, rᵢ is used to calculate the position of the uplink data retransmission subframe, and the specific calculating method is that the (pᵢ+rᵢ)ₜₕ subframe after subframe l is used for uplink data retransmission, wherein i=0,1. More specifically speaking, the second kind of timing relation of the present embodiment includes, when the backward compatible frame structure is configuration 1, the second kind of timing relation {l,p₀,r₀,p₁,r₁} is: {2,4,6,4,6}, {3,6,4,13,7}, {4,6,4,6,4}, {7,4,6,4,6}, {8,6,4,13,7}, {9,6,4,6,4}.

Step 2: The eNB notifies the Rel-11 UE in the cell to enable uplink/downlink subframe dynamic conversion function by broadcasting RRC signaling within the entire network or by using a special RRC signaling.

Step 3: Unless assured uplink resource scheduling information is received indicating the UE to transmit uplink data on a certain flexible subframe, the Rel-11 UE blindly searches each FlexSF for downlink control information, and it is assumed that downlink control information comprises a new 1-bit timing information field.

Step 4: The eNB sets flexible subframes 3, 4, 8 and 9 as downlink subframes, and allocates a half-static ACK/NACK channel (denoted as Hₛ) for each Rel-11 UE, wherein Hₛ can be used by a single UE exclusively or be shared by a plurality of UE. When the eNB transmits downlink control information, according to subframe numbers and downlink control information type, timing information field is set as follows:

If the downlink control information includes a downlink resource allocation indicator, in subframe 4, 8 and 9, the timing information field is set as “b₀=1” in the downlink control information that the downlink resource allocation indicates, so as to indicate the UE to feed back ACK/NACK using the second uplink subframe position corresponding to downlink data subframe described in step 1. In subframe 0, 1, 3, 5 and 6, the timing information field is set as “b₀=0” in the downlink control information that downlink resource allocation indicates, so as to indicate the UE to feed back the ACK/NACK using the first uplink subframe position corresponding to downlink data subframe described in step 1.

If the downlink control information comprises an uplink resource allocation indicator, the downlink control information comprising an uplink resource allocation indicator is transmitted on subframe 1 and subframe 6, wherein “b₀=0” in the timing information field, and uplink subframe index fields are both “c₀c₁=01”. Therein, “c₀” denotes the Least Significant Bit (LSB) of uplink subframe index field, while “c₁” denotes the Most Significant Bit (MSB) of uplink subframe index field.

Step 5: The UE determines the corresponding timing relation to communicate with the eNB according, to the value of timing information field bit “b₀” and that of “c₀c₁” in downlink control information received by different downlink subframes.

In the present embodiment shown in FIG. 9, if the downlink control information indicated by downlink resource allocation is received in subframe 4, 8 and 9, since “b₀=1” in the timing information field, the position of the second uplink subframe in the corresponding downlink data subframe in step 1 is adopted to feed back ACK/NACK, namely the UE feeds back ACK/NACK on subframe 2 using the statically allocated ACK/NACK channel resource Hₛ. In the present embodiment, since it is detected that “b₀=0” in the downlink control information in subframe 0, 1, 3, 5 and 6, the UE uses the first uplink subframe position of the corresponding downlink data subframe in step 1 to feed back ACK/NACK.

As shown in FIG. 6 in the present embodiment, when the above-mentioned downlink control information is received in subframe 0, 1 and 5, the UE feeds back ACK/NACK on subframe 2 using the statically allocated ACK/NACK channel resource Hₛ. When the downlink control information is detected in subframe 4, 6, 7, 8 and 9, the existing LTE timing relation of configuration 0 is maintained.

When the UE detects the downlink control information indicated by the uplink resource allocation in subframe 1 or subframe 6, since the timing information field is “b₀=0” and “c₀c₁=10”, the UE uses the first uplink subframe in the first type of timing relation defined for uplink subframes in step 1 to transmit data, and uses the first HARQ timing relation in the second kind of timing relation for uplink data retransmission. More specifically speaking, when it is detected that subframe 1 comprises downlink control information allocated by the uplink resource, the UE transmits uplink data on subframe 7 of the same radio frame, when data non-adaptive repeat happens, the UE adopts the first HARQ timing relation {7, 4, 6} for data retransmission. When downlink control information allocated by the uplink resource is detected in subframe 6, the UE transmits uplink data on subframe 2 of the next radio frame, when data non-adaptive repeat happens, the UE adopts the first HARQ timing relation {2, 4, 6} for data retransmission.

### Embodiment 5

It's assumed that the frame structure configuration of the system is configuration k, and it is assumed that k=5 in the present embodiment, namely the ratio of downlink data subframes (including the special subframe) is 90%. The eNB dynamically adjusts the ratio of downlink subframes in a radio frame according to data service change, it is assumed in the present embodiment that the eNB increases ratio of uplink subframes from 10% to 40% due to rise of uplink data service, so as to provide more uplink resources for uplink data transmission. The timing information field has m(1≦m≦3) bits in the new DCI, and m−1 in the present embodiment.

The method for indicating, HARQ timing relation in the present embodiment includes the following steps.

Step 1: predefining the HARQ timing relation.

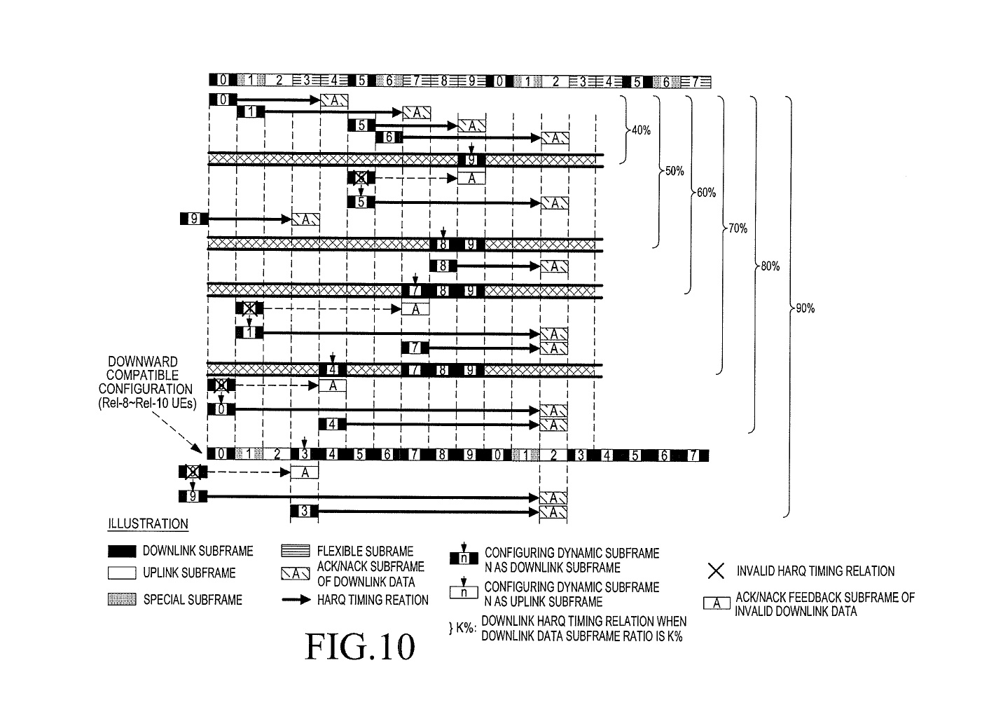

According to the backward compatible frame structure configuration, one or two subframe positions are predefined for each downlink data subframe for transmitting the corresponding ACK/NACK information, and symbol {n,k₀,k₁} signifies the timing relation among subframes. The physical meaning of {n,k₀,k₁} is: corresponding to the downlink data transmitted on the subframe numbered n, the position of the first subframe for transmitting ACK/NACK information is the k₀ₜₕ subframe after subframe n, while the position of the second subframe for transmitting ACK/NACK information is the k₁ₜₕ subframe after subframe n, wherein k₀,k₁ are both greater than or equal to 4. In the present embodiment, the backward compatible frame structure configuration is configuration 1, and the predefined timing relation {n,k₀,k₁} is {0,12,4}, {1,11,6}, {3,9,9}, {4,8,8}, {5,7,4}, {6,6,6}, {7,5,5}, {8,4,4}, {9,13,4}, as shown in FIG. 10.

According to the backward compatible frame structure configuration, two kinds of timing relations are predefined for each uplink subframe.

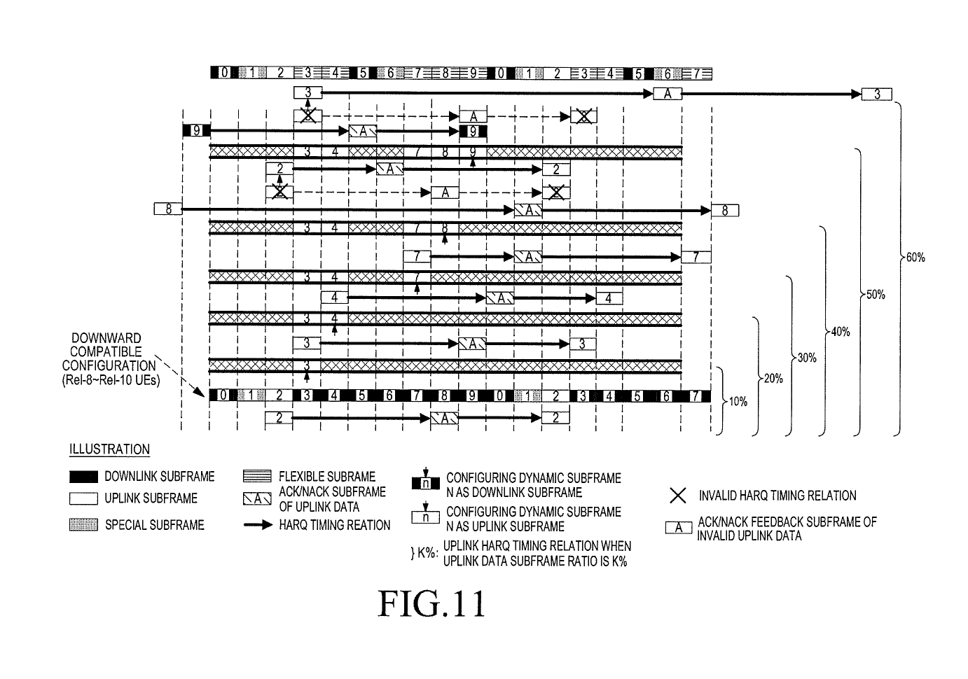

The first kind of timing relation is the timing relation between the DCI subframe and the scheduled uplink subframe thereof, as shown in FIG. 11. Two subframe positions are predefined for each downlink control information comprising an uplink resource indicator for uplink data transmission, and are signified as {m,g}. The physical meaning of {m,g} is: m is the number of the subframe on which downlink control information is transmitted, and the scheduled uplink data subframes thereof are two continuous subframes starting from the g^{th} subframe after subframe m, and both of the two continuous subframes belong to the set {2,3,4,7,8,9}. The specific subframe number is determined by the uplink subframe index field (UL index) in the downlink control information allocated by uplink resources. Therein, m=0, 1 . . . 9 denotes the subframe number in a single radio frame, g is greater than or equal to 4, and the meaning of UL index is the same as that of existing LTE system when the configuration is configuration 0. Namely, if bits in UL index are set as c₀c₁=01, the first of the two continuous subframes is used to transmit uplink data, and if bits in UL index are set as c₀c₁=10, the second of the two continuous subframes is used to transmit uplink data. Therein c₀ denotes the Least Significant Bit (LSB) of the UL index, while c₁ denotes the Most Significant Bit (MSB) of the UL index. More specifically, in the present embodiment, the first type of timing relation {m,g} is: {0,4}, {1,6}, {3,4}, {4,4}, {5,4}, {6,6}, {8,4}, {9,4}.

The second kind of timing relation is that between uplink data subframe and corresponding ACK/NACK subframe as well as uplink data retransmission subframe, still as shown in FIG. 11. At most, two different HARQ timing relations are predefined for each uplink subframe, denoted as {l,p₀,r₀,p₁,r₁}. Therein, {l,p₀,r₀} is used to calculate the first HARQ timing relation, while {l,p₁,r₁} is used to calculate the second HARQ timing relation. The physical meaning is: l denotes the number of the subframe for transmitting uplink data; pᵢ is used to calculate the position of the ACK/NACK subframe corresponding to uplink data, and specific calculating method is that the corresponding ACK/NACK subframe is the pᵢth subframe after uplink subframe 1; is used to calculate the position of the uplink data retransmission subframe, and the specific calculating method is that the (pᵢ+rᵢ)^{th} subframe after subframe l is used for the uplink data retransmission, wherein i=0,1. More specifically speaking, the second kind of timing relation of the present embodiment includes: when the backward compatible frame structure is configuration 5, the second kind of timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4}.

Step 2: The eNB notifies the Rel-11 UE in the cell to enable the uplink/downlink subframe dynamic conversion function by broadcasting RRC signaling within the entire network or by using a special RRC signaling.

Step 3: Unless assured uplink resource scheduling information is received indicating the UE to transmit uplink data on a certain flexible subframe, the Rel-11 UE blindly searches each FlexSF for downlink control information, and it is assumed that downlink control information comprises a new 1-bit timing, information field.

Step 4: The eNB sets subframe 3, 4 and 7 in the flexible subframe as uplink subframes. When the eNB transmits downlink control information, according to subframe numbers and downlink control information type, the timing information field is set as follows:

If the eNB transmits downlink control information comprising a downlink resource allocation indicator on subframe 0, 1 and 9, the timing information field bit is set as “b₀=1” in downlink control information, so as to indicate the UE to feed back the ACK/NACK using the second uplink subframe position corresponding to downlink data subframe described in step 1. If the eNB transmits downlink control information comprising a downlink resource allocation indicator on subframe 5, 6 and 8, the timing information field bit in the downlink control information comprising a downlink resource allocation indicator is set as “b₀=0”, so as to indicate the UE to feed back ACK/NACK using the first uplink subframe position corresponding to downlink data subframe described in step 1.

If the downlink control information comprising a downlink resource allocation indicator is transmitted on subframe 0, 1, 8 and 9, the timing information field bit is set as “b₀=0”, and the uplink subframe index field is set as “c₀c₁=01”.

Step 5: The UE determines the corresponding, timing relation to communicate with the eNB according to the value of the timing information field bit “b₀” in the downlink control information received by different downlink subframes.

In the present embodiment shown in FIG. 11, if the downlink control information indicated by downlink resource allocation is received in subframe 0, 1 and 9, since “b₀=1” in timing information field, the UE feeds back ACK/NACK on subframe 2 using the statically allocated ACK/NACK channel resource Hₛ; if the downlink control information indicated by downlink resource allocation is received in subframe 5, 6 and 7, since “c₀=0” in timing information field, the UE maintains the existing timing relation of LTE, and feeds back ACK/NACK information on subframe 2 using a method of implicit mapping ACK/NACK resource.

When the UE detects downlink control information indicated by the uplink resource allocation in subframe 0, 1, 8 or subframe 9, since the timing information field is “b₀=0” and uplink subframe index field is set as “c₀c₁=01”, when the downlink control information allocated by the uplink resource is detected in subframe 0, the UE transmits uplink data on subframe 4 of the same radio frame, and when data non-adaptive repeat happens, the UE adopts the first HARQ timing relation {4,6,4} for data retransmission. When downlink control information allocated by uplink resource is detected in subframe 1, the UE transmits uplink data on subframe 7 of the same radio frame, and when data non-adaptive repeat happens, the UE adopts the first HARQ timing relation {7,4,6} for data retransmission. When downlink control information allocated by uplink resource is detected in subframe 8, the UE transmits uplink data on subframe 2 of the next radio frame, and when data non-adaptive repeat happens, the UE adopts the first HARQ timing relation {2,6,4} for data retransmission. When downlink control information allocated by uplink resource is detected in subframe 9, the UE transmit uplink data on subframe 3 of the next radio frame, and when data non-adaptive repeat happens, the UE adopts the first HARQ timing relation {3,6,4} for data retransmission.

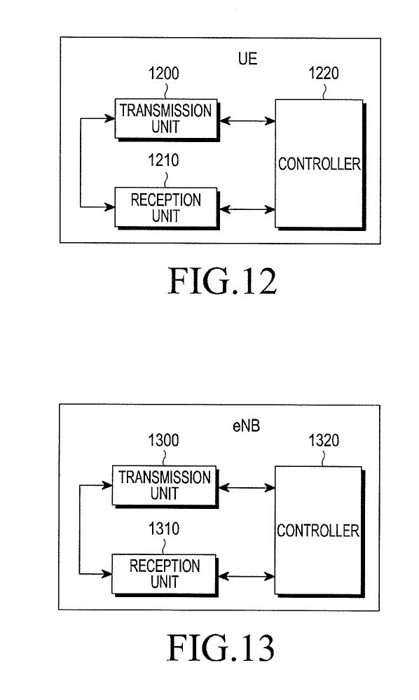

FIG. 12 is illustrating the UE apparatus according to an exemplary embodiment of the present invention.

Referring to FIG. 12, the UE includes transmission unit (1200), reception unit (1210), and controller (1220). The transmission unit (1200) and reception unit (1210) respectively include a transmission module and a reception module for communicating with the eNB according to an exemplary embodiment of the present invention. The reception unit (1210) receives information related to a uplink/downlink subframe dynamic conversion function from an evolved NodeB (eNB), and receives an updated HARQ timing relation from the eNB.

The controller (1220) performs an operation of the UE based on FIG. 3 to FIG. 11 according to an exemplary embodiment of the present invention.

The controller (1220) identifies the backward compatible subframe configuration information of the current cell by system information, communicates with the eNB in accordance with the updated HARQ timing relation, when the eNB is performed the dynamic subframe conversion corresponding to the updated HARQ timing relation.

FIG. 13 is illustrating the eNB apparatus according to an exemplary embodiment of the present invention.

Referring to FIG. 13, the eNB includes transmission unit (1300), reception unit (1310), and controller (1320). The transmission unit (1300) and reception unit (1310) respectively include a transmission module and a reception module for communicating with the UE according to an exemplary embodiment of the present invention. The transmission unit (1300) notifies the UE information related to uplink/downlink subframe dynamic conversion function.

The controller (1320) performs an operation of the eNB based on FIG. 3 to FIG. 11 according to an exemplary embodiment of the present invention.

The controller (1320) dynamically updates HARQ timing relation, and notifies the UE of an updated HARQ timing relation, performs a dynamic subframe conversion corresponding to the updated HARQ timing relation, and communicates with the UE in accordance with the updated HARQ timing relation.

It can be seen from the above described embodiments that, in the method for indication HARQ timing relation in a wireless communication system provided by the present invention, the eNB notifies the UE in the cell to enable uplink/downlink subframe dynamic conversion function, and the eNB dynamically converses the uplink/downlink subframes and dynamically updates HARQ timing information for the UE according to the conversed uplink/downlink subframe configuration, and indicates the UE of the updated HARQ timing relation, so that a Rel-11 UE may highly efficiently use dynamic flexible subframes, and efficiently support backward compatible equipment to work normally. Finally, the object of changing frame structure dynamically according to data service change more accurately and timely in a TD-LTE system can be reached.

The above illustration is just a preferable embodiment of the present invention and not used to limit the present invention. Any modification, equivalent substitute and improvement within spirit of the present invention are within the protection scope of the present invention.

What is claimed is:

1. A method for indicating a Hybrid Automatic Repeat Request (HARQ) timing relation, comprising:
notifying, by an evolved NodeB (eNB), a User Equipment (UE) to enable uplink/downlink subframe dynamic conversion function;
dynamically updating, by the eNB, HARQ timing relation, and notifying the UE of an updated HARQ timing relation;
performing, by the eNB, the dynamic subframe conversion corresponding to the updated HARQ timing relation; and
communicating, by the eNB, with User Equipment (UE) in accordance with the updated HARQ timing relation.

2. The method according to claim 1, wherein the eNB dynamically converts the subframes, comprising:
when uplink subframes need to be added, converting continuous downlink subframes into uplink subframes; and
when downlink subframes need to be added, converting continuous uplink subframes into downlink subframes.

3. The method according to claim 2, wherein the converting of continuous downlink subframes into uplink subframes comprises:
following an order of {f₀,f₁, . . . }, wherein {f₀,f₁, . . . } refers to converting subframe f₀ into an uplink subframe first, and then converting subframe f₁ into an uplink subframe;
if the prior-conversion subframe is configured as configuration 2, {f₀, f₁, . . . } being {3,4,8,9} or {8,9,3,4};
if the prior-conversion subframe is configured as configuration 3, {f₀, f₁, . . . } being {7,8,9}.
if the prior-conversion subframe is configured as configuration 4, {f₀,f₁, . . . } being {7,8,9}; and
if the prior-conversion subframe is configured as configuration 5, {f₀, f₁, . . . } being {3,4,7,8,9},
wherein the converting continuous uplink subframes into downlink subframes comprises:
following an order of {f₀, f₁, . . . }, wherein {f₀,f₁, . . . } refers to converting subframe f₀ into a downlink subframe first, and then converting subframe f₁ into a downlink subframe;
if the prior-conversion subframe is configured as configuration 0, {f₀, f₁, . . . } being {9,8,7,4,3}.
if the prior-conversion subframe is configured as configuration 3, {f₀, f₁, . . . } being {4,3}; and
if the prior-conversion subframe is configured as configuration 6, {f₀, f₁, . . . } being {8,7,4,3}.

4. The method according to claim 3, further comprising:
predefining HARQ timing relations corresponding to various subframe configurations, the HARQ timing relation comprising at least one of:
a timing relation between the downlink data subframe and the corresponding ACK/NACK subframe;
a timing relation between the downlink control information subframe and the uplink subframe scheduled by the downlink control information subframe; and
a timing relation between the uplink data subframe and the corresponding ACK/NACK subframe and the uplink data retransmission subframe;
the eNB notifying the UE of the updated HARQ timing relation comprising the eNB notifying UE of the updated HARQ timing relation via the downlink control information.

5. The method according to claim 4, wherein:
the downlink control information is transmitted in a specified search space of UE in downlink control information area.

6. The method according to claim 5, wherein:
the step for predefining the timing relation between the downlink data subframe and the corresponding, ACK/NACK subframe comprises:
predefining the timing relation {n,k₀,k₁}, wherein k₀ and k₁ are both greater than or equal to 4; and
{n,k₀,k₁} includes two kinds of timing relations, wherein:
the first kind of timing relation being, when a subframe n is used to transmit downlink data, the k₀^{th} subframe after subframe n is used to transmit the corresponding ACK/NACK information;
the second kind of timing relation being, when the subframe n is used to transmit downlink data, the k₁^{th} subframe after subframe n is used to transmit the corresponding ACK/NACK information;
the eNB notifying the UE of the updated HARQ timing relation via downlink control information comprising: the eNB notifying the UE via timing information field in the downlink control information to take one of the above mentioned two timing relations as the timing relation between current downlink data subframe and corresponding ACK/NACK subframe.

7. The method according to claim 6, wherein:
corresponding to configuration 1, the timing relation {n,k₀,k₁} is: {0,7,12}, {1,6,11}, {3,4,9}, {4,4,8}, {5,7,7}, {6,6,6}, {7,5,5}, {8,5,4}, {9,4,13};
corresponding to configuration 2, the timing relation {n,k₀,k₁} is: {0,7,12}, {1,6,11}, {3,4,9}, {4,8,8}, {5,7,7}, {6,6,6}, {7,5,5}, {8,4,4}, {9,8,13}.
corresponding to configuration 3, timing relation {n,k₀,k₁} is: {0,4,12}, {1,11,11}, {3,9,9}, {4,9,8}, {5,7,7}, {6,6,6}, {7,6,5}, {8,5,4}, {9,5,13};
corresponding to configuration 4, timing relation {n,k₀,k₁} is: {0,12,12}, {1,11,11}, {3,9,9}, {4,8,8}, {5,7,7}, {6,7,6}, {7,6,5}, {8,5,4}, {9,4,13};
corresponding to configuration 5, timing relation {n,k₀,k₁} is: {0,12,4}, {1,11,6}, {3,9,9}, {4,8,8}, {5,7,4}, {6,6,6}, {7,5,5}, {8,4,4}, {9,13,4};
corresponding, to configuration 6, timing relation {n,k₀,k₁} is: {0,7,12}, {1,7,11}, {3,9,9}, {4,9,8}, {5,7,7}, {6,7,6}, {7,6,5}, {8,5,4}, {9,5,13}.

8. The method according to claim 7, wherein:
the number of the timing information field bits is 1 bit; and
one value of the timing information field is used to indicate the UE to use the first kind of timing relation as the timing relation between a current downlink data subframe and a corresponding ACK/NACK subframe, while the other value of the timing information field is used to indicate the UE to use the second kind of timing, relation as the timing relation between the current downlink data subframe and the corresponding ACK/NACK subframe.

9. The method according to claim 8, further comprising:
the eNB statically configuring an ACK/NACK channel for each UE in advance;
wherein when the UE receives downlink control information in a downlink subframe, and the value of the timing information field in this downlink control information indicates the UE to use the second kind of timing relation as that between current downlink data subframe and corresponding ACK/NACK subframe, the UE uses the ACK/NACK channel statically configured by the eNB to transmit ACK/NACK information in accordance with subframe n.

10. The method according to claim 8, wherein:
the number of the timing information field bits is two bits;
one of the two bits being taken as the timing information bit, one value of the timing information bit being used to indicate the UE to use the first kind of timing relation as that between a current downlink data subframe and a corresponding ACK/NACK subframe, and the other value of the timing information bit being used to indicate the UE to use the second kind of timing relation as that between the current downlink data subframe and the corresponding ACK/NACK subframe;
the method further comprising:
the eNB statically configuring a group of ACK/NACK channels for a group of UEs in advance, and 4 values of the two bits corresponding to each of the group of ACK/NACK channels respectively;
when the UE receives the downlink control information in a downlink subframe and the value of timing information field in this downlink control information indicates the UE to use the above second timing relation as that between the current downlink data subframe and the corresponding ACK/NACK subframe, the UE uses the ACK/NACK channel statically configured by the eNB to transmit the ACK/NACK information in accordance with subframe n.

11. The method according to claim 5, wherein:
predefining the timing relation between the downlink control information subframe and the uplink subframe scheduled by the downlink control information comprising:
predefining two candidate subframe positions for each downlink control information subframe comprising an uplink resource scheduling indicator for uplink data transmission, and the timing relation being signified with symbol {m,g};
{m,g} comprising two kinds of timing relations, wherein:
the first kind of timing relation being, when downlink control information transmitted on subframe m includes an uplink resource scheduling indicator, the scheduled uplink subframe is the first of the two continuous subframes starting from the g^{th} subframe after subframe m;
the second kind of timing relation being, when downlink control information transmitted on subframe m includes an uplink resource scheduling indicator, the scheduled uplink subframe is the second of the two continuous subframes starting from the g^{th} subframe after subframe m;
both of the two subframes belonging to subframe set of {2,3,4,7,8,9}, and g being greater than or equal to 4;
the eNB notifying the UE of the updated HARQ timing relation via the downlink control information comprising:
the eNB notifying the UE via the uplink subframe index field in the downlink control information transmitted on subframe m to take one of the above mentioned two timing relations as the timing relation between current downlink control information subframe and the uplink subframe scheduled by this downlink control information subframe.

12. The method according to claim 11, wherein:
the timing relation {m,g} is: {0,4}, {1,6}, {3,4}, {4,4}, {5,4}, {6,6}, {8,4}, {9,4}.

13. The method according to claim 12, wherein:
the uplink subframe index field includes 2 bits, signified as c₀c₁;
c₀c₁=01 meaning using the first kind of timing relation as the timing relation between current downlink control information subframe and the uplink subframe scheduled by this downlink control information subframe, and c₀c₁=10 meaning using the second kind of timing relation as the timing relation between current downlink control information subframe and the uplink subframe scheduled by this downlink control information subframe.

14. The method according to claim 5, wherein:
predefining the timing relation between uplink data subframe and corresponding ACK/NACK subframe as well as uplink data retransmission subframe comprising:
predefining the timing relation {l,p₀,r₀,p₁,r₁}, {l,p₀,r₀,p₁,r₁} comprising two kinds of timing relations, wherein:
the first kind of timing relation being, when subframe 1 is used to transmit uplink data, the p₀ₜₕ subframe after subframe 1 is used to transmit corresponding ACK/NACK information, and the (p₀r₀)^{th} subframe after subframe 1 is used for uplink data retransmission;
the second kind of timing relation being, when subframe 1 is used to transmit uplink data, the pᵢ^{th} subframe after subframe 1 is used to transmit corresponding ACK/NACK information, and the (p₁+r₁)^{th} subframe after subframe 1 is used for uplink data retransmission;
the eNB notifying the UE via the timing information field in the downlink control information to take one of the above mentioned two timing relations as the timing relation between current uplink data subframe and corresponding ACK/NACK subframe as well as uplink data retransmission subframe.

15. The method according claim 14, wherein:
corresponding to configuration 0, timing relation {l,p₀,r₀,p₁,r₁} is: {2,4,7,4,6}, {3,7,4,5,4}, {4,6,7,4,4}, {7,4,7,8,7}, {8,7,4,7,7}, {9,6,7,6,7}.
corresponding to configuration 1, timing relation {l,p₀,r₀,p₁,r₁} is: {2,4,6,4,6}, {3,6,4,13,7}, {4,6,4,6,4}, {8,6,4,13,7}, {9,6,4,6,4};
corresponding to configuration 2, timing relation {l,p₀,r₀,p₁,r₁} is: {2,6,4,4,6}, {3,6,4,13,7}, {4,6,4,6,4}, {7,6,4,4,6}, {8,13,7,13,7}, {9,6,4,6,4};
corresponding to configuration 3, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4};
corresponding, to configuration 4, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4};
corresponding to configuration 5, timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4};
corresponding to configuration 6, timing relation {l,p₀,r₀,p₁,r₁} is: {2,4,7,6,4}, {3,6,5,7,4}, {4,6,7,4,4}, {7,4,7,8,7}, {8,7,7,7,7}, {9,6,4,6,4}.

16. The method according claim 15, wherein:
the number of the timing information field includes 1 bit; and
one value of the timing information field meaning taking the above mentioned first kind of timing relation as that between current uplink data subframe and corresponding ACK/NACK subframe as well as uplink data retransmission subframe, and another value of the timing information field meaning taking the above mentioned second kind of timing relation as that between current uplink data subframe and corresponding ACK/NACK subframe as well as uplink data retransmission subframe.

17. The method according to claim 3, wherein the eNB notifying the UE of the updated HARQ timing relation comprises:
the eNB notifying the UE of system information reading period; and
at the time corresponding to the system information reading period, the eNB sending a piece of system information carrying subframe configuration information corresponding to the updated HARQ timing relation to the UE, the UE learning the subframe configuration information in this system information, and current used HARQ timing relation being determined according to the subframe configuration information.

18. The method according to claim 17, the method further comprising:
presetting corresponding relations between the bit values and configuration 0˜6;
wherein configuring system information carrying the subframe configuration information by the eNB comprises:
using the 3 unused bits in system information and, according to the preset corresponding relations, filling the 3 bits with bit values corresponding to the dynamically conversed subframe configurations corresponding to the updated HARQ timing relation.

19. The method according to claim 18, wherein the system information comprises the at least one of the main information block and the system information block 1.

20. The method according to claim 3, wherein:
the method further comprises presetting corresponding relations between the bit values and configuration 0˜6; and
the eNB notifying the UE of the updated HARQ timing relation comprises a 3-bit information being carried in the RRC signaling or Media Access Control (MAC) signaling sent to UE by the eNB, according to the preset corresponding relations, the 3 bits in the RRC signaling or MAC signaling being filled with bit values corresponding to the subframe configuration corresponding to the updated HARQ timing relation.

21. The method according to claim 3, wherein:
the method further comprises presetting corresponding relations between the bit values and configuration 0˜6; and
the eNB notifying the UE of the updated HARQ timing relation comprises a 3-bit timing information field being carried in the downlink control information, according to the preset corresponding relations, the timing information field being filled with bit values corresponding to the subframe configuration corresponding to the updated HARQ timing relation.

22. A method for indicating by a User Equipment (UE) Hybrid Automatic Repeat Request (HARQ) timing relation, comprising:
identifying the backward compatible subframe configuration information of current cell by system information;
receiving information related to an uplink/downlink subframe dynamic conversion function from an evolved NodeB (eNB);
receiving an updated HARQ timing relation from the eNB; and
communicating with the eNB in accordance with the updated HARQ timing relation, when the eNB is performed, the dynamic subframe conversion corresponding to the updated HARQ timing, relation.

23. The method according to claim 22, wherein the eNB dynamically converses the subframes comprising:
when uplink subframes need to be added, converting, continuous downlink subframes into uplink subframes; and
when downlink subframes need to be added, converting continuous uplink subframes into downlink subframes.

24. The method according to claim 23, wherein the converting continuous downlink subframes into uplink subframes comprises:
following an order of {f₀, f₁, . . . }, wherein {f₀, f₁, . . . } meaning: converting subframe f₀ into an uplink subframe first, and then converting subframe f₁ into an uplink subframe;
if the prior-conversion subframe is configured as configuration 2, is {f₀, f₁, . . . } is {3,4,8,9} or {8,9,3,4};
if the prior-conversion subframe is configured as configuration 3, is {f₀, f₁, . . . } is {7,8,9};
if the prior-conversion subframe is configured as configuration 4, {f₀, f₁, . . . } is {4,7,8,9}; and
if the prior-conversion subframe is configured as configuration 5, {f₀, f₁, . . . } is {3,4,7,8,9}, and
wherein the converting continuous uplink subframes into downlink subframes comprises:
following an order of {f₀, f₁, . . . }, wherein {f₀, f₁, . . . } meaning: conversing subframe f₀ into a downlink subframe first, and then converting subframe f₁ into a downlink subframe;
if the prior-conversion subframe is configured as configuration 0, {f₀, f₁, . . . } is {9,8,7,4,3};
if the prior-conversion subframe is configured as configuration 3, {f₀,f₁, . . . } is {4,3}; and
if the prior-conversion subframe is configured as configuration 6, {f₀, f₁, . . . } is {8,7,4,3}.

25. The method according to claim 24, further comprising:
predefining HARQ timing relations corresponding to various subframe configurations, the HARQ timing relation comprising at least one of:
a timing relation between the downlink data subframe and the corresponding ACK/NACK subframe;
a timing relation between the downlink control information subframe and the uplink subframe scheduled by the downlink control information subframe; and
a timing relation between the uplink data subframe and the corresponding ACK/NACK subframe and the uplink data retransmission subframe;
the eNB notifying the UE of the updated HARQ timing relation comprising: the eNB notifying the UE of the updated HARQ timing relation via the said downlink control information.

26. The method according to claim 25, wherein:
the downlink control information is transmitted in a specified search space of the UE in the downlink control information area.

27. The method according to claim 26, wherein:
the step for predefining the timing relation between the downlink data subframe and the corresponding ACK/NACK subframe comprises predefining the timing relation {n,k₀,k₁}, wherein k₀ and k₁ are both greater than or equal to 4;
{n,k₀,k₁} includes two kinds of timing relations, wherein:
the first kind of timing relation being, when subframe n is used to transmit downlink data, the k₀^{th} subframe after subframe n is used to transmit the corresponding ACK/NACK information;
the second kind of timing relation being, when subframe n is used to transmit downlink data, the k₁^{th} subframe after subframe n is used to transmit the corresponding ACK/NACK information;
the eNB notifying the UE of the updated HARQ timing relation via downlink control information comprising the eNB notifying the UE via the timing information field in the downlink control information to take one of the two timing relations as the timing relation between the current downlink data subframe and the corresponding ACK/NACK subframe.

28. The method according to claim 27, wherein:
corresponding to configuration 1, the timing relation {n,k₀,k₁} is: {0,7,12}, {1,6,11}, {3,4,9}, {4,4,8}, {5,7,7}, {6,6,6}, {7,5,5}, {8,5,4}, {9,4,13};
corresponding to configuration 2, the timing relation {n,k₀,k₁} is: {0,7,12}, {1,6,11}, {3,4,9}, {4,8,8}, {5,7,7}, {6,6,6}, {7,5,5}, {8,4,4}, {9,8,13};
corresponding to configuration 3, the timing relation {n,k₀,k₁} is: {0,4,12}, {1,11,11}, {3,9,9}, {4,9,8}, {5,7,7}, {6,6,6}, {7,6,5}, {8,5,4}, {9,5,13};
corresponding to configuration 4, the timing relation {n,k₀,k₁} is: {0,12,12}, {1,11,11}, {3,9,9}, {4,8,8}, {5,7,7}, {6,7,6}, {7,6,5}, {8,5,4}, {9,4,13};
corresponding to configuration 5, the timing relation {n,k₀,k₁} is: {0,12,4}, {1,11,6}, {3,9,9}, {4,8,8}, {5,7,4}, {6,6,6}, {7,5,5}, {8,4,4}, {9,13,4};
corresponding to configuration 6, the timing relation {n,k₀,k₁} is: {0,7,12}, {1,7,11}, {3,9,9}, {4,9,8}, {5,7,7}, {6,7,6}, {7,6,5}, {8,5,4}, {9,5,13}.

29. The method according to claim 28, wherein:
the number of the timing information field bits is 1 bit; and
one value of the timing information field is used to indicate the UE to use the first kind of timing relation as the timing relation between the current downlink data subframe and the corresponding ACK/NACK subframe, while the other value of the timing information field being used to indicate UE to use the second kind of timing relation as the timing relation between the current downlink data subframe and the corresponding ACK/NACK subframe.

30. The method according to claim 29, further comprising:
the eNB statically configuring an ACK/NACK channel for each UE in advance; and
when the UE receives downlink control information in a downlink subframe, and the value of the timing information field in this downlink control information indicates the UE to use the above second kind of timing relation as that between the current downlink data subframe and the corresponding ACK/NACK subframe, the UE using the ACK/NACK channel statically configured by the eNB to transmit the ACK/NACK information in accordance with subframe n.

31. The method according to claim 28, wherein:
the number of the timing information field bits is two bits;
one of the two bits being taken as timing information bit, one value of the timing information bit being used to indicate the UE to use the first kind of timing relation as that between the current downlink data subframe and the corresponding ACK/NACK subframe, and the other value of the timing information bit being used to indicate the UE to use the second kind of timing relation as that between the current downlink data subframe and the corresponding ACK/NACK subframe;
the method further comprising:
the eNB statically configuring a group of ACK/NACK channels for a group of UEs in advance, and 4 values of the two bits corresponding to each of the group of ACK/NACK channels respectively;
when the UE receives downlink control information in a downlink subframe and value of timing information field in this downlink control information indicates UE to use the above second timing relation as that between the current downlink data subframe and the corresponding ACK/NACK subframe, the UE using the ACK/NACK channel statically configured by the eNB to transmit the ACK/NACK information in accordance with subframe n.

32. The method according to claim 26, wherein:
predefining the timing relation between downlink control information subframe and the uplink subframe scheduled by the downlink control information comprising: predefining two candidate subframe positions for each downlink control information subframe comprising, an uplink resource scheduling indicator for uplink data transmission, and this timing relation being signified with symbol {m,g};
{m,g} comprising two kinds of timing relations, wherein:
the first kind of timing relation being, when downlink control information transmitted on subframe m includes an uplink resource scheduling indicator, the scheduled uplink subframe is the first of the two continuous subframes starting from the g^{th} subframe after subframe m.
the second kind of timing relation being, when downlink control information transmitted on subframe m includes an uplink resource scheduling indicator, the scheduled uplink subframe is the second of the two continuous subframes starting from the g^{th} subframe after subframe m;
both of the two subframes belonging to subframe set of {2,3,4,7,8,9}, and g being greater than or equal to 4;
the eNB notifying the UE of the updated HARQ timing relation via the downlink control information comprising the eNB notifying the UE via the uplink subframe index field in the downlink control information transmitted on subframe m to take one of the two timing relations as the timing relation between the current downlink control information subframe and the uplink subframe scheduled by this downlink control information subframe.

33. The method according to claim 32, wherein:
the timing relation {m,g} is: {0,4}, {1,6}, {3,4}, {4,4}, {5,4}, {6,6}, {8,4}, {9,4}.

34. The method according to claim 33, wherein:
the uplink subframe index field taking 2 bits, signified as c₀c₁,
c₀c₁=01 meaning using the first kind of timing relation as the timing relation between the current downlink control information subframe and the uplink subframe scheduled by this downlink control information subframe, and c₀c₁=10 meaning using the second kind of timing relation as the timing relation between the current downlink control information subframe and the uplink subframe scheduled by this downlink control information subframe.

35. The method according to claim 26, wherein:
predefining the timing relation between the uplink data subframe and the corresponding ACK/NACK subframe and the uplink data retransmission subframe comprising:
predefining timing relation {l,p₀,r₀,p₁,r₁}, {l,p₀,r₀,p₁,r₁} comprising two kinds of timing relations, wherein:
the first kind of timing relation being, when subframe 1 is used to transmit uplink data, the p₀ₜₕ subframe after subframe 1 is used to transmit corresponding ACK/NACK information, and the (p₀+r₀)^{th} subframe after subframe 1 is used for uplink data retransmission;
the second kind of timing relation being, when subframe 1 is used to transmit uplink data, the p₁^{th} subframe after subframe 1 is used to transmit corresponding ACK/NACK information, and the (p₁+r₁)^{th} subframe after subframe 1 is used for uplink data retransmission;
the eNB notifying the UE via the timing information field in the downlink control information to take one of the two timing relations as the timing relation between the current uplink data subframe and the corresponding ACK/NACK subframe and the uplink data retransmission subframe.

36. The method according claim 35, wherein:
corresponding to configuration 0, the timing relation {l,p₀,r₀,p₁,r₁} is: {2,4,7,4,6}, {3,7,4,5,4}, {4,6,7,4,4}, {7,4,7,8,7}, {8,7,4,7,7}, {9,6,7,6,7};
corresponding to configuration 1, the timing relation {l,p₀,r₀,p₁,r₁} is: {2,4,6,4,6}, {3,6,4,13,7}, {4,6,4 6,4}, {7,4,6,4,6}, {8,6,4,13,7}, {9,6,4,6,4};
corresponding to configuration 2, the timing relation {l,p₀,r₀,p₁,r₁} is: {2,6,4,4,6}, {3,6,4,13,7}, {4,6,4,6,4}, {7,6,4,4,6}, {8,13,7,13,7}, {9,6,4,6,4};
corresponding to configuration 3, the timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4};
corresponding to configuration 4, the timing relation {l,p₀,r₀,p₁,r₁} is: {2,6,4, 4,6}, {3,6,4,13,7}, {4,6,4,6,4}, {7,4,6,4,6}, {8,13,7,13,7}, {9,6,4,6,4};
corresponding to configuration 5, the timing relation {l,p₀,r₀,p₁,r₁} is: {2,6,4,4,6}, {3,6,4,13,7}, {4,6,4,6,4}, {7,4,6,4,6}, {8,13,7,13,7}, {9,6,4,6,4};
corresponding to configuration 6, the timing relation {l,p₀,r₀,p₁,r₁} is: {2,4,7,6,4}, {3,6,5,7,4}, {4,6,7,4,4}, {7,4,7,8,7}, {8,7,7,7,7}, {9,6,4,6,4}.

37. The method according claim 36, wherein:
the number of the timing information field being 1 bit,
one value of the timing information field meaning taking the first kind of timing relation as that between the current uplink data subframe and the corresponding ACK/NACK subframe and the uplink data retransmission subframe, and the other value of the timing information field meaning taking the second kind of timing relation as that between the current uplink data subframe and the corresponding ACK/NACK subframe and the uplink data retransmission subframe.

38. The method according to claim 24, the eNB notifying the UE of the updated HARQ timing relation comprising:
the eNB notifying the UE of the system information reading period;
at the time corresponding to the system information reading period, the eNB sending a piece of system information carrying subframe configuration information corresponding to the updated HARQ timing relation to the UE, the UE learning the subframe configuration information in this system information, and the current used HARQ timing relation being determined according to the subframe configuration information.

39. The method according to claim 38, the method further comprising:
presetting corresponding relations between the bit values and configuration 0˜6;
wherein configuring system information carrying the subframe configuration information by the eNB comprises using the 3 unused bits in the system information and, according to the preset corresponding relations, filling the 3 bits with bit values corresponding to the dynamically conversed subframe configurations corresponding to the updated HARQ timing relation.

40. The method according to claim 39, wherein the system information comprises at least one of the main information block and the system information block 1.

41. The method according to claim 24, the method further comprising:
presetting corresponding relations between the bit values and configuration 0˜6;
wherein the eNB notifying the UE of the updated HARQ timing relation comprises a 3-bit information being carried in the RRC signaling or Media Access Control (MAC) signaling sent to UE by eNB, according to the preset corresponding relations, the 3 bits in the RRC signaling or MAC signaling being filled with bit values corresponding to the subframe configuration corresponding to the updated HARQ timing relation.

42. The method according to claim 24, the method further comprising:
presetting corresponding relations between the bit values and configuration 0˜6;
wherein the eNB notifying the UE of the updated HARQ timing relation comprises a 3-bit timing information field being carried in the downlink control information, according to the preset corresponding relations, the timing information field being filled with bit values corresponding to the subframe configuration corresponding to the updated HARQ timing relation.

43. An evolved NodeB (eNB) apparatus for indicating Hybrid Automatic Repeat Request (HARQ) timing relation, wherein, comprising
a transmission unit configured to notify UE information related to an uplink/downlink subframe dynamic conversion function; and
a controller configured to:
dynamically update the HARQ timing relation, and notify the UE of an updated HARQ timing relation,
perform the dynamic subframe conversion corresponding to the updated HARQ timing relation, and
communicate with User Equipment (UE) in accordance with the updated HARQ timing relation.

44. A User Equipment (UE) apparatus for indicating Hybrid Automatic Repeat Request (HARQ) timing relation, comprising:
a controller configured to identify a backward compatible subframe configuration information of a current cell by system information; and
a reception unit configured to receive information related to an uplink/downlink subframe dynamic conversion function from an evolved NodeB (eNB), and receive an updated HARQ timing relation from the eNB,
wherein the controller is configured to communicate with the eNB in accordance with the updated HARQ timing relation, when the eNB performs the dynamic subframe conversion corresponding to the updated HARQ timing relation.
